(19) United States
(12) Patent Application Publication
(10) Pub. No.: US 2018/0295414 A1
(43) Pub. Date: Oct. 11, 2018

(54) METHOD AND DEVICE FOR PROCESSING VOICE COMMAND THROUGH UIBC

(71) Applicant: LG ELECTRONICS INC., Seoul (KR)

(72) Inventors: Giwon PARK, Seoul (KR); Byungjoo LEE, Seoul (KR); Dongcheol KIM, Seoul (KR); Hyunhee PARK, Seoul (KR); Taesung LIM, Seoul (KR)

(21) Appl. No.: 15/575,713

(22) PCT Filed: May 4, 2016
(86) PCT No.: PCT/KR2016/004700

§ 371 Date: Nov. 20, 2017

Related U.S. Application Data
(60) Provisional application No. 62/165,139, filed on May 21, 2015.
(60) Provisional application No. 62/166,671, filed on May 26, 2015.
(60) Provisional application No. 62/166,673, filed on May 26, 2015.
(60) Provisional application No. 62/166,672, filed on May 26, 2015.
(60) Provisional application No. 62/166,669, filed on May 26, 2015.
(60) Provisional application No. 62/172,036, filed on Jun. 6, 2015.

(51) Int. Cl. H04N 21/4415; G10L 15/22

(52) U.S. Cl. CPC H04N 21/4415; H04W 84/12; G10L 2015/223; G10L 15/22

(57) ABSTRACT

A method for processing a voice command through a UIBC may comprise the steps of: transmitting, by a first WFD device, an M3 request message for requesting information on the VCDC capability of a second WFD device to the second WFC device; receiving, by the first WFC device, an M3 response message from the second WFC device in response to the M3 request message, wherein the M3 response message includes input category information and VCDC capability information configured for a VCDC of the second WFD device; transmitting, by the first WFC device, an M4 request message to the second WFD device in an RTSP initialization state, wherein the M4 request message includes the input category information and initial configuration VCDC capability information configured for the VCDC; and receiving, by the first WFD device, an M4 response message from the second WFD device in response to the M4 request message.

### CROSS-REFERENCE TO RELATED APPLICATIONS

This application is the National Stage filing under 35 U.S.C. 371 of International Application No. PCT/KR2016/004700, filed on May 4, 2016, which claims the benefit of U.S. Provisional Applications No. 62/165,139 filed on May 21, 2015, No. 62/166,671 filed on May 26, 2015, No. 62/166,673 filed on May 26, 2015, No. 62/166,672 filed on May 26, 2015, No. 62/166,669 filed on May 26, 2015, No. 62/172,036 filed on Jun. 6, 2015, and No. 62/170,142 filed on Jun. 3, 2015, the contents of which are all hereby incorporated by reference herein in their entirety.

### BACKGROUND OF THE INVENTION

### Field of the Invention

The present invention relates to a Wireless Fidelity Display (WFD) and, more particularly, to a method and apparatus for processing voice commands through a User Input Back Channel (UIBC).

### Related Art

The performance of mobile devices is greatly improved up to a degree comparable to that of personal computers (PCs), but there is still a limitation in the screen size.

Particularly, as the portability of smartphones is important, the screen size of 6 inches is considered as the Maginot line, and a display of 6 inches may still be a small screen for a user who enjoys multimedia contents.

Accordingly, a technology for enabling a video viewed on a mobile device to be viewed on a large-screen TV (television) or a monitor is being studied. This technology may be represented by a term called wireless display transmission technology. The wireless display transmission technology may be roughly divided into content transmission and mirroring (screen casting). Content transmission needs to be linked with Video on Demand (VOD) service, not transmitting a mobile device screen as it is. The content transmission is a method of transmitting video signals, and the mirroring is a method of transmitting content files to a remote device by streaming and again displaying the content files on a large screen such as a TV.

The mirroring (screen casting), as the name implies, is a method of displaying the images outputted to a mobile device at the same time as if the images were mirrored. The mirroring (screen casting) is similar to a method of projecting a computer screen on a projector by connecting by wired methods such as D-Subminiature, RGB (D-sub), Digital Visual Interface (DVI) and High-Definition Multimedia Interface (HDMI) upon presentation. The mirroring method is advantageous in that pixel information of the original screen can be wirelessly transmitted without being dependent on a specific service in real-time.

WiFi Miracast is being studied as a wireless display transmission technology using WiFi. Miracast is a wireless video transmission standard and a wireless display transmission technology created by the WiFi Alliance. Miracast is a type of mirroring (screen casting) technology that compresses images and sounds to send the compressed images and sounds to a wireless LAN, and then decompresses the images and sounds in a dongle or an integral type of receiver to display the images and sounds on the screen.

### SUMMARY OF THE INVENTION

The present invention provides a method of processing a voice command through UIBC.

The present invention also provides a voice command processing device through UIBC.

In an aspect, provided is a method for processing a voice command through a User Input Back Channel (UIBC), the method including: sending, a first WiFi Display (WFD) device, a Real-Time Streaming Protocol (RTSP) Message (M) 3 request message to a second WFD device to request information about a Voice Command Device Category (VCDC) capability of the second WFD device; receiving, by the first WFD device, an RTSP M3 response message in response to the RTSP M3 request message from the second WFD device, the RTSP M3 response message including input category information and VCDC capability information set to the VCDC of the second WFD device; sending, by the first WFD device, an RTSP M4 request message in an RTSP initiation state to the second WFD device, the RTSP M4 request message including input category information and initial setting VCDC capability information set to the VCDC; and receiving, by the first WFD device, an RTSP M4 response message from the second WFD device in response to the RTSP M4 request message, wherein: the first WFD device is a device supporting streaming of multimedia contents, the second WFD device is a device receiving and rendering the multimedia contents from the first WFD device through a Peer-to-Peer (P2P) link with the first WFD device, and the VCDC capability information includes information about a plurality of voice-based operation control commands for control of the multimedia contents played in the first WFD device and the second WFD device by the second WFD device, respectively.

In another aspect, provided is a first WiFi Display (WFD) device for performing voice command processing through a User Input Back Channel (UIBC), the device including: a communication unit for communicating with a second WFD device; and a processor operably connected to the communication unit, wherein: the processor sends a Real-Time Streaming Protocol (RTSP) M3 request message to the second WFD device to request information about a Voice Command Device Category (VCDC) capability of the second WFD device, receives an RTSP M3 response message in response to the RTSP M3 request message from the second WFD device, the RTSP M3 response message including input category information and VCDC capability information set to the VCDC of the second WFD device, sends a RTSP M4 request message in an RTSP initiation state to the second WFD device, the RTSP M4 request message including input category information and initial setting VCDC capability information set to the VCDC, and receives an RTSP M4 response message from the second WFD device in response to the RTSP M4 request message; the first WFD device is a device supporting streaming of multimedia contents; the second WFD device is a device receiving and rendering the multimedia contents from the first WFD device through a Peer-to-Peer (P2P) link with the first WFD device; and the VCDC capability information includes information about a plurality of voice-based operation control commands for control of the multimedia contents played in the first WFD device and the second WFD device by the second WFD device, respectively.

A voice command of a user inputted through a WFD sink can be transmitted to a WFD source on a UIBC to drive an application for playing multimedia contents on the WFD source.

### BRIEF DESCRIPTION OF THE DRAWINGS

FIG. 1 is a conceptual view illustrating a WiFi Direct Service (WFDS) framework component.

FIG. 2 is a conceptual view illustrating a WFD network.

FIG. 3 is a conceptual view illustrating a WFD session.

FIG. 4 is a conceptual view illustrating a WFD session configuration method.

FIG. 5 is a conceptual view illustrating a network between a WFD source and a WFD sink.

FIG. 6 is a conceptual view illustrating a WFD capability exchange and negotiation procedure.

FIG. 7 is a conceptual view illustrating a WFD session establishment procedure.

FIG. 8 is a flowchart illustrating a UIBC capability negotiation between a WFD source and a WFD sink according to an embodiment of the present invention.

FIG. 9 is a flowchart illustrating a UIBC capability negotiation between a WFD source and a WFD sink according to an embodiment of the present invention.

FIG. 10 is a flowchart illustrating a UIBC capability negotiation between a WFD source and a WFD sink according to an embodiment of the present invention.

FIG. 11 is a flowchart illustrating a UIBC capability negotiation between a WFD source and a WFD sink according to an embodiment of the present invention.

FIG. 12 is a flowchart illustrating a UIBC capability negotiation between a WFD source and a WFD sink according to an embodiment of the present invention.

FIG. 13 is a conceptual view illustrating a method of transmitting an RTSP control message according to an embodiment of the present invention.

FIG. 14 is a conceptual view illustrating a UIBC input message format according to an embodiment of the present invention.

FIG. 15 is a flowchart illustrating a UIBC capability negotiation method according to an embodiment of the present invention.

FIG. 16 is a flowchart illustrating a UIBC capability negotiation method according to an embodiment of the present invention.

FIG. 17 is a flowchart illustrating a capability negotiation and capability negotiation procedure of a RAC for delivering voice commands according to an embodiment of the present invention.

FIG. 18 is a conceptual view illustrating a method of transmitting a voice command of a user through a UIBC according to an embodiment of the present invention.

FIG. 19 is a conceptual view illustrating a method of transmitting a voice command of a user through a UIBC according to an embodiment of the present invention.

FIG. 20 is a view illustrating a wireless device to which an embodiment of the present invention can be applied.

### DESCRIPTION OF EXEMPLARY EMBODIMENTS

In an existing wireless LAN system, an operation between apparatuses (AP and STA (station)) in an infrastructure basic service set (BSS) in which an access point (AP) functions as a hub is mainly defined. The AP may be responsible for a physical layer support function for wireless/wired connections, a routing function for devices on the network, a function of adding/removing devices to/from the network, and a service provisioning function. That is, in the existing wireless LAN system, the devices in the network are connected through the AP, and are not directly connected to each other.

A Wi-Fi Direct standard is defined as a technique for supporting direct connection between devices. The Wi-Fi Direct is a direct communication technology that enables easy connection between devices (or stations (STAs)) without an access point that is basically required in an existing WLAN system. When the WiFi Direct is used, a connection between devices may be established without complicated setup processes, and various services may be provided to a user.

In Wi-Fi Alliance (WFA), a Wi-Fi Direct Service (WFDS) that supports various services (e.g., Send, Play, Display, and Print,) using Wi-Fi Direct links is being studied. According to WFDS, an application may be controlled or managed by a service platform called an Application Service Platform (ASP).

WFDS devices by supported WFDS include devices that support wireless LAN systems such as display devices, printers, digital cameras, projectors, and smart phones. Also, the WFDS device may include an STA and an AP. WFDS devices within a WI-DS network may be directly connected to each other.

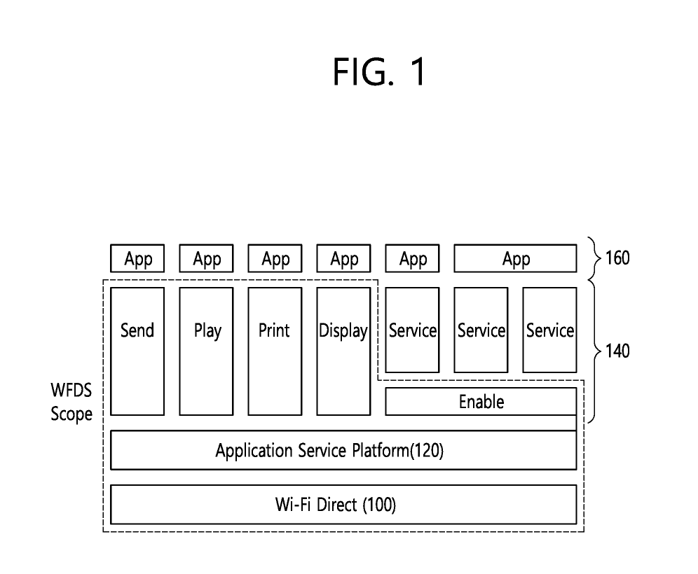

FIG. 1 is a conceptual view illustrating a WiFi Direct Service (WFDS) framework component.

Referring to FIG. 1, a WFDS framework may include a Wi-Fi Direct layer 100, an ASP 120, a service layer 140, and an application layer 160.

The Wi-Fi Direct layer 100 is a medium access control (MAC) layer defined in the Wi-Fi Direct standard. Under the Wi-Fi Direct layer 100, a wireless connection may be configured by a physical layer (not shown) compatible with the Wi-Fi PHY. Over the Wi-Fi Direct layer 100, an Application Service Platform (ASP) 120 is defined.

The ASP 120 is a common shared platform, and performs session management, service command processing, and inter-ASP control and security functions between the application layer 160 thereover and the Wi-Fi Direct layer 100 thereunder.

The service layer 140 is defined over the ASP 120. For example, in the service layer 140, four basic services such as Send, Play, Display, and Print services and services defined in a third party application may be supported. Also, the service layer 140 may support a Wi-Fi Serial Bus (WSB), a Wi-Fi Docking, or a Neighbor Awareness Network (NAN).

The application layer 160 may provide a User Interface (UI), may represent information in a human-recognizable form and deliver a user input to a lower layer.

Hereinafter, a Wireless Fidelity (WiFi) Display (WFD) among WFDS is more specifically disclosed in the embodiment of the present invention.

The WFD standard is defined to transmit audio/video (AV) data between devices while satisfying high quality and low latency. Through a WFD network (WFD session) to which the WFD standard is applied, Wi-Fi devices may be connected to each other in a peer-to-peer manner without going through a home network, an office network, or a hot-spot network. Hereinafter, a device for transmitting and receiving data according to the WFD standard may be expressed by a term called a WFD device. WFD devices in a WFD network may search for information (e.g., capability information) about the WFD device, and establish a WFD session, and then render the contents through the WFD session.

The WFD session may be a network between a source device providing contents and a sink device receiving and rendering contents. The source device may also be referred to as a term, the WFD source, and the sink device may also be referred to as a term, the WFD sink. The WFD source may mirror the data existing on the display (or screen) of the WFD source to the display of the WFD sink.

The WFD source and the WFD sink may exchange a first sequence message with each other to perform device search and service search procedures. After the device search and service search procedures between the WFD source and the WFD sink are completed, Internet Protocol (IP) addresses may be assigned to each of the WFD source and the WFD sink. A Transmission Control Protocol (TCP) connection is established between the WFD source and the WFD sink, and thereafter Real-Time Streaming Protocol (RTSP) and Real-Time Protocol (RTP) stacks for the WFD source and the WFD sink may be activated.

The capability negotiation procedure between the WFD source and the WFD sink is performed through the RTSP, and while the capability negotiation procedure is being performed, the WFD source and the WFD sink may exchange RTSP-based messages (M (message) 1 to M4). Thereafter, the WFD source and the WFD sink may exchange WFD session control messages. A data session through the RTP may also be established between the WFD source and the WFD sink. In the WFD network, a User Datagram Protocol (UDP) may be used for data transport.

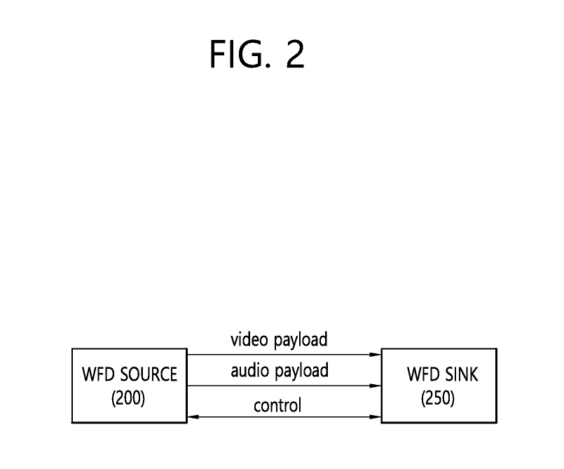

FIG. 2 is a conceptual view illustrating a WFD network.

Referring to FIG. 2, a WFD source 200 and a WFD sink 250 as WFD devices may be connected based on WiFi-P2P.

Here, the WFD source 200 may be a device for supporting the streaming of multimedia contents through a WiFi Peer-to-Peer (P2P) link, and the WFD sink 250 may be a device that receives multimedia contents from the WFD source 200 through the P2P link and performs a procedure of generating images and/or sounds. The procedure of generating images and/or sounds may be expressed as a term called rendering

The WFD sink 250 may be divided into a primary sink and a secondary sink. In particular, the secondary sink may render only an audio payload when connected independently of the WFD source 200.

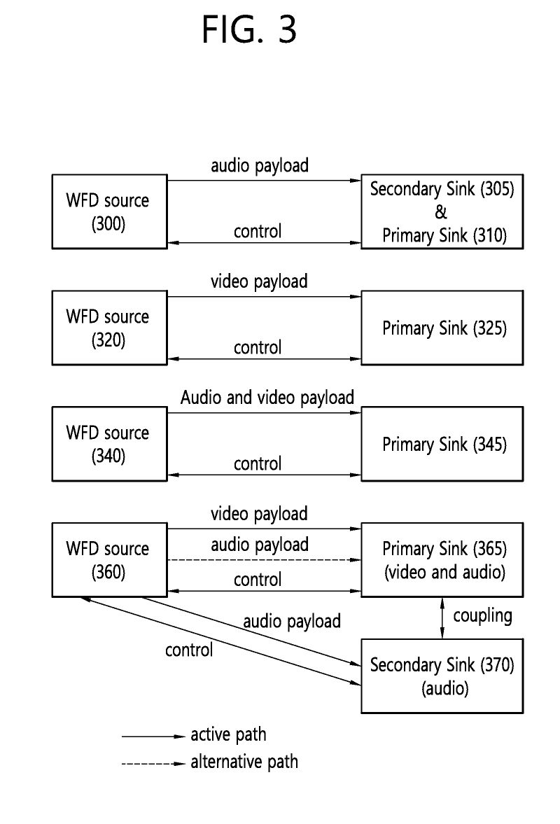

FIG. 3 is a conceptual view illustrating a WFD session.

The first top of FIG. 3 is an audio-only session. A WFD source 300 may be connected to either a primary sink 305 or a secondary sink 310 through the audio-only session.

The second top of FIG. 3 is a video-only session. A WFD source 320 may be connected to a primary sink 325.

The third top of FIG. 3 is an audio and video session, and similarly to the video-only session, a WFD source 340 may be connected to a primary sink 345.

The fourth top of FIG. 3 discloses a session connection in a coupled WFD sink operation. In the coupled WFD sink operation, a primary sink 365 may render a video, and a secondary sink 370 may render an audio, respectively. Alternatively, the primary sink 365 may render both video and audio.

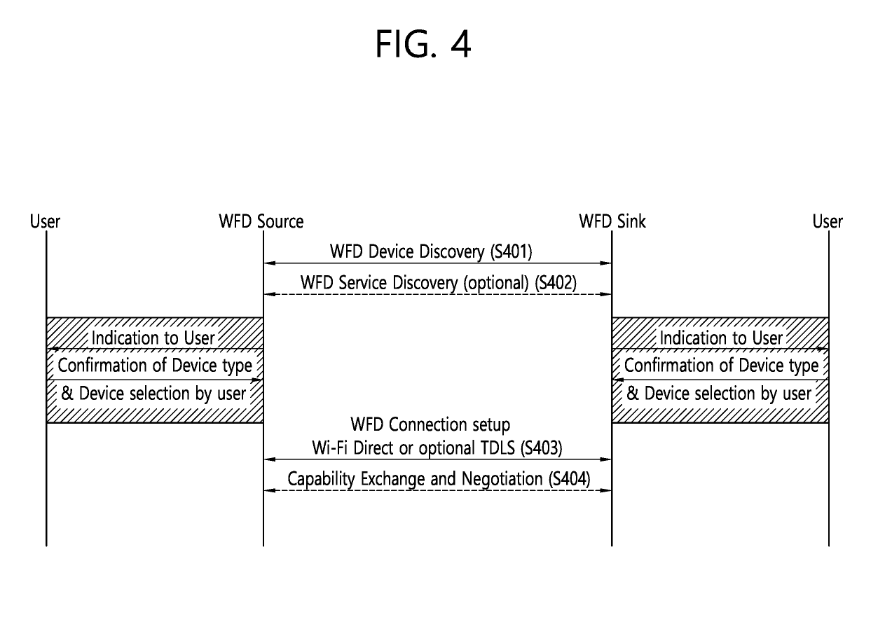

Such a WFD session may be established after performing a procedure as shown in FIG. 4 below.

FIG. 4 is a conceptual view illustrating a WFD session configuration method.

Referring to FIG. 4, after a WFD device discovery (S401), a WFD service discovery (S402), a WFD connection setup (S403), and a capability exchange and negotiation (S404) are performed, a WFD session may be set.

Specifically, in the WFD device discovery procedure (S401), the WFD source may find a peer device for WFD, i.e., a WFD sink, through the WFD device discovery procedure.

A beacon frame, a probe request frame, and a probe response frame, etc. transmitted for WFD device discovery by the WFD source and the WFD sink may include a WFD Information Element (IE). Here, the WFD IE may be an information element including information related to WFD such as device type and device status.

The WFD source may send a probe request frame including the WFD IE to the WFD sink, and the WFD sink may transmit a probe response frame including the WFD IE in response to the probe request frame. If the WFD device is associated with an infrastructure AP and operates as a Wi-Fi P2P device, the probe request frame may include a WFD IE and a P2P information element. The probe response frame, which is a response to the probe request frame, may be transmitted through the channel through which the probe request frame is received, and may include both the P2P IE and the WFD IE.

Unmentioned contents related to the WFD device discovery may comply with the ‘Wi-Fi Display Technical Specification’ and/or the ‘Wi-Fi Peer-to-Peer (P2P) Technical Specification Wi-Fi Direct Service Addendum’ documents, which may be applied to the following descriptions.

In the WFD service discovery procedure (S402), a discovery for the service capability may be performed between the WFD source and the WFD sink performing the WFD device discovery. For example, when the WFD source transmits a service discovery request frame including information about the WFD capability, the WFD sink may send a service discovery response frame including information about the WFD capability in response to the service discovery request frame. The WFD service discovery procedure may be an optional procedure.

The probe request frame and the probe response frame used in the WFD device discovery procedure for performing the WFD service discovery procedure may include information indicating whether the WFD device has the capability to support the service discovery procedure.

In the WFD connection setup procedure (S403), the WFD device performing the WFD device discovery procedure and optionally the WFD service discovery procedure may select a WFD device for the WFD connection setup. After the WFD device for WFD connection setup is selected according to policy or user input, any one connectivity scheme of Wi-Fi P2P and tunneled direct link service (TDLS) may be used for WFD connection. The WFD devices may determine a connection method based on an associated Basic Service Set Identifier (BSSID) subelement that is transported together with the preferred connectivity information and the WFD information element.

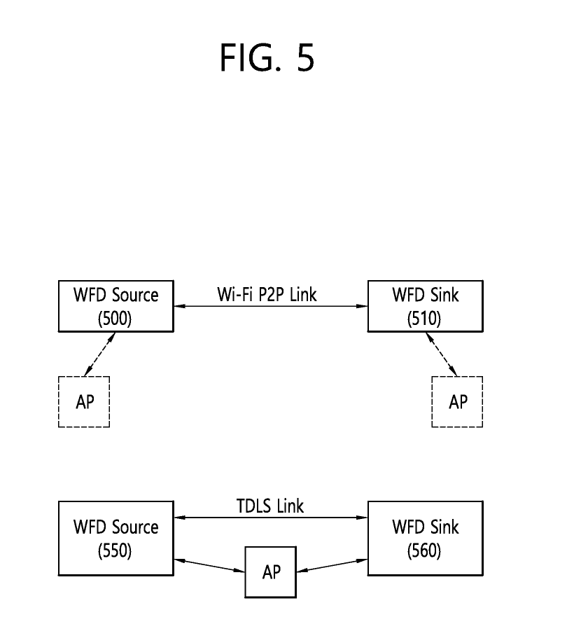

FIG. 5 is a conceptual view illustrating a network between a WFD source and a WFD sink.

In the top of FIG. 5, a connection between a WFD source 500 and a WFD sink 510 based on the Wi-Fi P2P is disclosed, and in the bottom of FIG. 5, a connection between a WFD source 550 and a WFD sink 560 based on the TDLS link is disclosed.

As shown in the top of FIG. 5, the AP may be common or may be different in regard to the WFD source 500 and the WFD sink 510. Alternatively, the AP may not exist. When performing the WFD connection using the TDLS link as shown in the bottom of FIG. 5, the WFD source 550 and the WFD sink 560 need to maintain a connection with the same AP.

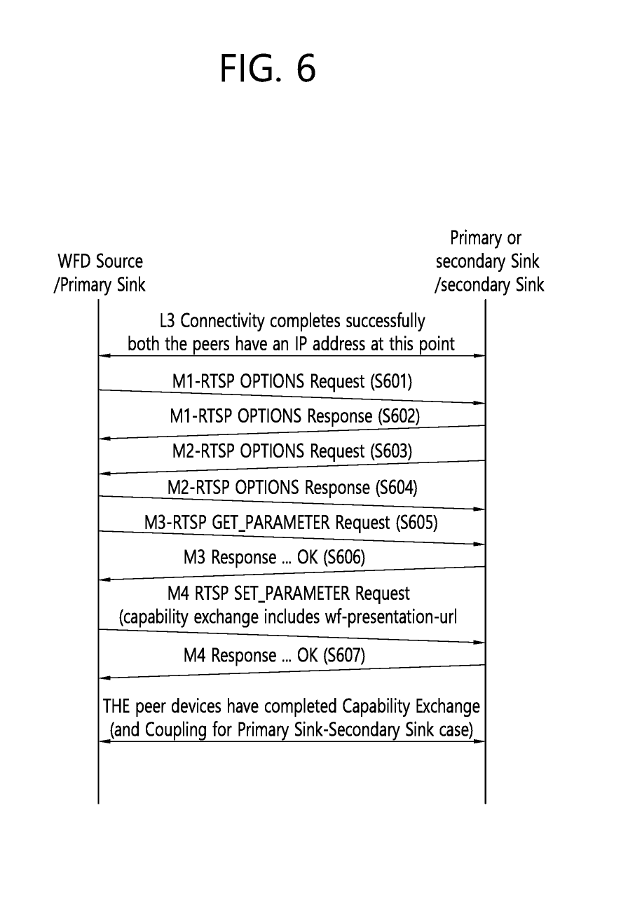

The WFD capability exchange and negotiation procedure may be performed after the WFD connection setup procedure between the WFD devices. Through the WFD capability exchange and negotiation, the WFD source and the WFD sink may mutually exchange at least one of codecs supported by each other, profile information of codecs, level information of codecs, and resolution information of codecs. The WFD capability exchange and negotiation may be performed by exchanging messages using Real-time Streaming Protocol (RTSP). Also, a set of parameters defining an audio/video payload during the WFD session may be determined. The WFD capability exchange and negotiation procedure may be performed by exchanges from RTSP M1 to RTSP M4 messages as shown in FIG. 6, which will be described later.

After the WFD exchange and negotiation procedure, the WFD session establishment procedure may be performed.

FIG. 6 is a conceptual view illustrating a WFD capability exchange and negotiation procedure.

Referring to FIG. 6, the WFD source may send an RTSP M1 request message to initiate the RSTP procedure and the WFD capability negotiation (operation S601).

The RTSP M1 request message may include an RTSP options request to determine a set of RTSP methods supported by the WFD sink. The WFD sink receiving the RTSP M1 request message may transmit an RTSP M1 response message in which the RTSP methods that the WFD sink itself supports are enumerated (operation S602).

Thereafter, the WFD sink may send an RTSP M2 request message to determine a set of RTSP methods that the WFD source supports (operation S603).

When the RTSP M2 request message is received, the WFD source may respond with an RTSP M2 response message in which the RTSP methods that the WFD source itself supports are enumerated (operation S604).

The WFD source may send an RTSP M3 request message (RTSP GET_PARAMETER request message) specifying a list of WFD capabilities that the WFD source desires to know (operation S605).

When the RTSP M3 request message is received, the WFD sink may respond with an RTSP M3 response message (RTSP GET_PARAMETER response message) (operation S606).

Based on the RTSP M3 response message, the WFD source may determine an optimal set of parameters to be used during the WFD session, and may send an RTSP M4 request message (RTSP SET_PARAMETER request message) including the determined set of parameters to the WFD sink.

The WFD sink receiving the RTSP M4 request message may send an RTSP M4 response message (RTSP SET_PARAMETER response message) (operation S607).

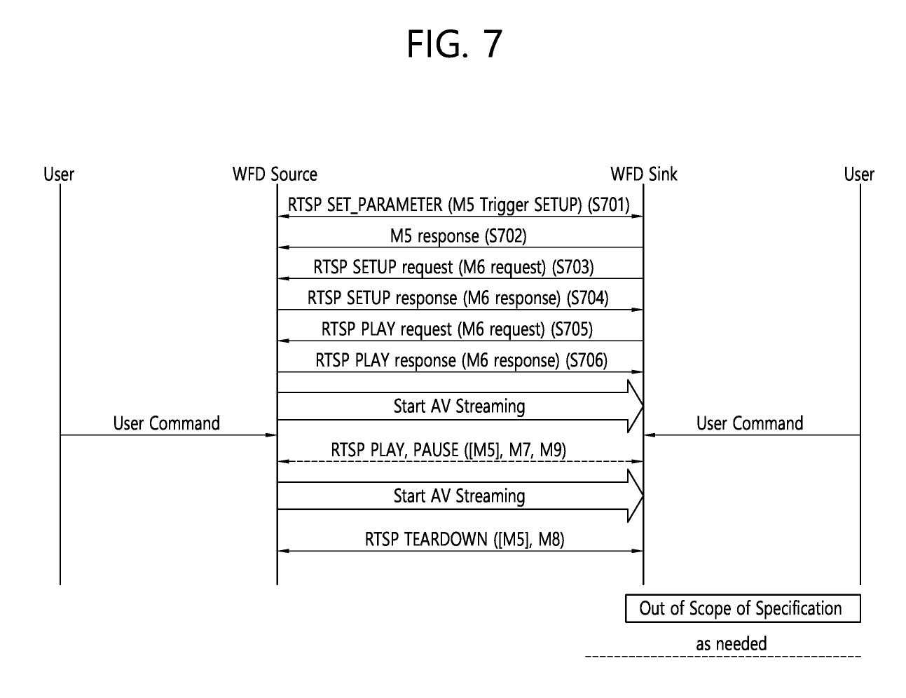

FIG. 7 is a conceptual view illustrating a WFD session establishment procedure.

In FIG. 7, the WFD source/WFD sinks that have performed WFD capability exchange and negotiation may establish a WFD session. Specifically, the WFD source may transmit an RTSP SET parameter request message (RTSP M5 Trigger SETUP request) to the WFD sink (S701).

The WFD sink may send an RTSP M5 response message in response to the RTSP SET parameter request message (operation S702).

When the RTSP M5 message including a trigger parameter setup is successfully exchanged, the WFD sink may transmit an RTSP SETUP request message (RTSP M6 request) to the WFD source (operation S703).

When the RTSP M6 request message is received, the WFD source may respond with an RTSP SETUP response message (RTSP M6 response) (operation S704).

Successful establishment of the RTSP session may be instructed through the setting of the status code of the RTSP M6 response message.

After a successful exchange of the RTSP M6 message, the WFD sink may send an RTSP M7 request message to the source device to indicate that it is ready to receive the RTP stream (operation S705), and the WFD source may respond with an RTSP PLAY response message (RTSP M7 response message) (operation S706). Successful establishment of the WFD session may be instructed based on the status code of the RTSP PLAY response message.

After the WFD session is established, the WFD source transmits, to the WFD sink, an RTSP M3 request message (RTSP GET_PARAMETER request message) for acquiring capability for at least one RTSP parameter supported by the WFD sink, an RTSP M4 request message for setting at least one RTSP parameter value corresponding to the WFD session for capacity renegotiation between the WFD source and the WFD sink for Audio/Video (AV) formal renewal, an RTSP M5 request message for triggering the WFD sink to transmit an RTSP pause request message (RTSP M9 request message), an RTSP M12 request message for indicating that the WFD source enters WFD standby mode, an RTSP M14 request message for selecting input types to be used in a User Input Back Channel (UIBC), input device and other parameters, or an RTSP M15 request message for enabling or disabling the User Input Back Channel (UIBC). The WFD sink receiving the above-described RTSP request messages from the WFD source may respond with RTSP response messages.

Thereafter, the WFD sink may transmit, to WFD source, an RTSP M7 request message (RTSP PLAY request message) for starting (or resuming) audio/video streaming, an RTSP M9 request message (RTSP pause request message) for pausing audio/video streaming transmitted from the WFD source to the WFD sink, an RTSP M10 request message for requesting the WFD source to change an audio rendering device, an RTSP M11 request message indicating a change of the active connector type, an RTSP M12 request message indicating that the WFD sink has entered the WFD standby mode, an RTSP M13 request message for requesting the WFD source to refresh an Instantaneous Decoding Refresh (IDR), an RTSP M14 request message for selecting an input type to be used in the UIBC, input devices and other parameters, RTSP M15 request message for enabling or disabling the UIBC. The WFD source receiving the above-enumerated RTSP request messages from the WFD sink may respond with RTSP response messages.

When the WFD session is established and audio/video streaming begins, the WFD source and the WFD sink may proceed with audio/video streaming using codecs commonly supported by both of the WFD source and the WFD sink. As the codecs commonly supported by the WFD source and the WFD sink are used, the interoperability between the WFD source and the WFD sink may be guaranteed.

The WFD communication is based on the WFD IE, and the format of the WFD IE may be defined as shown in Table 1 below.

TABLE 1

| | | Value | |
|---|---|---|---|
| | Size | (Hexa- | |
| Field | (octets) | decimal) | Description |
| Element ID | 1 | DD | IEEE 802.11 vendor specific |
| | | | usage |
| Length | 1 | Variable | Length of the following fields |
| | | | in the IE in octets. The length |
| | | | field is variable and set to 4 |
| | | | plus the total length of WFD |
| | | | subelements. |
| OUI | 3 | 50-6F-9A | WFA Specific OUI |
| OUI Type | 1 | 0A | Identifying the type or version |
| | | | of the WFD IE. Setting to 0x0A |
| | | | indicates WFA WFD v1.0 |
| WFD | Variable | | One or more WFD subelements |
| subelements | | | appear in the WFD IE |

Table 1 includes element ID field, length field, WFA-specific OUI field, OUI field indicating the type/version of WFD IE, and WFD subelement field. The WFD subelement field has a format as shown in Table 2 below.

TABLE 2

| | | Value | |
|---|---|---|---|
| | Size | (Hexa- | |
| Field | (octets) | decimal) | Description |
| Subelement ID | 1 | | Identifying the type of WFD |
| | | | subelement. The specific |
| | | | value is defined in Table 5-3. |
| Length | 2 | Variable | Length of the following |
| | | | fields in the subelement |
| Subelements | Variable | | Subelement specific information |
| body field | | | fields |

The subelement ID may be defined as Table 3 below.

TABLE 3

| Subelement | |
|---|---|
| ID(Decimal) | Notes |
| 0 | WFD Device Information |
| 1 | Associated BSSID |
| 2 | WFD Audio Formats |
| 3 | WFD Video Formats |
| 4 | WFD 3D Video Formats |
| 5 | WFD Content Protection |
| 6 | Coupled Sink Information |
| 7 | WFD Extended Capability |
| 8 | Local IP Address |
| 9 | WFD Session Information |
| 10 | Alternative MAC Address |
| 11-255 | Reserved |

Referring to Table 3, the subelement ID field of one octet may indicate what information the WFD subelement contains. Specifically, the values of the subelement ID fields 0, 1, . . . , 10 may indicate that the subelements are WFD Device Information subelement, Associated BSSID subelement, WFD Audio Formats subelement, WFD Video Formats subelement, WFD 3D Video Formats subelement, WFD Content Protection subelement, Coupled Sink Information subelement, WFD Extended Capability subelement, Local IP Address subelement, WFD Session Information subelement, and Alternative MAC Address subelement, respectively. Here, the WFD Device Information subelement may include information necessary to decide whether to attempt to pair with the WFD device and create a session. The Associated BSSID subelement may be used to indicate the address of the currently associated AP. The WFD Audio Formats subelement, WFD Video Formats subelement, and WFD 3D Video Formats subelement may be used to indicate the capability of the WFD device related to audio, video, and 3D video, respectively. The WFD Content Protection subelement deliver information related to the content protection method, and the Coupled Sink Information subelement may deliver information about the state of the coupled sink, the MAC address, and the like. The WFD Extended Capability subelement is used to deliver various pieces of capability information of other WFD devices, and the Local IP Address subelement may be used to deliver an IP address to a WFD peer in the TDLS setup process. The WFD Session Information subelement may include information such as a list of WFD device information technicians in a WFD group. When the WFD connection method requires an interface (e.g., a MAC address) different from that used in the device discovery, the Alternative MAC Address subelement may deliver relevant information.

The User Input Back Channel (UIBC) may be a channel for transmitting a user input to a user interface present in the WFD sink to the WFD source. UIBC user inputs delivered through the UIBC may be packetized using a common packet header, and may be deliver over a Transmission Control Protocol (TCP)/Internet Protocol (IP). A user input category may include a generic category and a Human Interface Device Class (HIDC) category. The generic category (or an integrated category) may be used for a user input that is not dependent on a device being processed at an application level. A generic user input may have a format using a generic input body (or an integrated input body). The generic user input may include conceptual inputs such as zoom and scroll, as well as inputs such as mouse and keyboard events. The HIDC may be used for a user input generated by a human input device (HID) such as a remote control and a keyboard. An HIDC user input may have a format using an HIDC input body.

In the past, a voice command processing through the UIBC was not supported. According to an embodiment of the present invention, the WFD sink may send a voice command of a user received through a user input device (e.g., a voice command device) implemented in the WFD sink to the WFD source, and the WFD source may be controlled according to the received voice command of a user. When a voice command is used, the WFD source may be controlled by a simple and fast method without using a hand.

For example, a user voice command may be delivered from the WFD sink to the WFD source through UIBC data, and may control the screen of the WFD source. The UIBC data for delivering voice commands may be defined as a generic category and a Human Interface Device Class (HIDC) category, or may also be defined as a separate category (e.g., a Voice Command Device Category (VCDC)). When the UIBC data for delivering a voice command is defined as a separate category, the UIBC data may have a format using a VCDC generic input body as a VCDC user input.

For example, in regard to video mirroring between the WFD sink and the WFD source, the following voice commands may be inputted into the WFD sink, and then may be delivered to the WFD source through the UIBC data on the UIBC to control the video player that is playing.

The voice commands may be commands for control the video player, such as Play, Stop, Forward, Rewind, Screen Rotation, Mute, Unmute, Full Screen, Original Size, or Optimal Screen.

According to an embodiment of the present invention, a Voice Command Device Category (VCDC) and a VCDC input body format may be defined to support voice command processing on the UIBC. The VCDC input body format may include one or more VCDC input messages.

The VCDC body format may be defined as shown in Table 4 below.

TABLE 4

| Field | Size | Notes |
|---|---|---|
| Voice Command Device | | see Table 5 |
| (VCD) Type ID | | |
| Application ID | | Application ID (e.g., Gom player, |
| | | Internet Explorer, etc.) controlled |
| | | through UIBC data transport |
| Length | | Length of the VC value in octets. |
| Voice Command (VC) | | see Table 6 |
| value | | |

TABLE 5

| Value of Voice Command | |
|---|---|
| Device (VCD) Type ID | VCD Type |
| 0 | TV |
| 1 | Smart Phone |
| 2 | Tablet PC |
| 3 | Electric washing machine |
| 4 | Refrigerator |
| 5 | Monitor |
| 6-254 | Reserved |

The voice command device may mean a WFD sink, or may be a separate user input device connected to the WFD sink.

TABLE 6

| | | |
|---|---|---|
| Field | Size | Notes |

| | |
|---|---|
| Voice Command Key code(Voice Command value) | see Table 7 |

According to the embodiment of the present invention, a user voice command inputted through the WFD sink may be included in the UIBC data and transferred to the WFD source, and thus the screen being mirrored from the WFD source to WFD sink may be controlled by the WFD sink. A voice command key code (or voice command value, voice command operation code) corresponding to the user voice command may be included in the VCDC input body and transmitted as UIBC data.

Table 7 shows specific voice command key codes (voice command values).

TABLE 7

| | Voice | |
|---|---|---|
| Action | command | Key code |
| Play-When a user delivers a command “Play” by voice, a command | “Play” | TBS |
| key for playing a Player (separated by Application ID) running on | | |
| the source device is included in the VCDC Input message. | | |
| Stop-When a user delivers a command “Stop” by voice, a command | “Stop” | TBD |
| key for stopping a Player (separated by Application ID) running on | | |
| the source device is included in the VCDC Input message. | | |
| Forward-When a user delivers a command “Forward” by voice, a | “Forward” | TBD |
| command key for forwarding the play screen of a Player (separated | | |
| by Application ID) running on the source device is included in the | | |
| VCDC Input message. | | |
| Rewind-When a user delivers a command “Rewind” by voice, a | “Rewind” | TBD |
| command key for rewinding the play screen of a Player (separated | | |
| by Application ID) running on the source device is included in the | | |
| Generic Input message. | | |
| Screen Rotation-Landscape-When a user delivers a command | “Screen | TBD |
| “Screen Rotation” by voice, a command key for rotating the play | Rotation” | |
| screen of a Player (separated by Application ID) running on the | | |
| source device is included in the VCDC Input message. - | | |
| For example, when the current playback & mirroring screen is | | |
| portrait type, a command key for rotating the playback screen into | | |
| landscape type is included in the VCDC Input message when a user | | |
| delivers a command “Screen Rotation” by voice. | | |
| Screen Rotation-Portrait-When a user delivers a command “Screen | “Screen | TBD |
| Rotation” by voice, a command key for rotating the play screen of a | Rotation” | |
| Player (separated by Application ID) running on the source device | | |
| is included in the VCDC Input message. - | | |
| For example, when the current playback & mirroring screen is | | |
| landscape type, a command key for rotating the playback screen | | |
| into portrait type is included in the VCDC Input message when a | | |
| user delivers a command “Screen Rotation” by voice. | | |
| Mute-When a user delivers a command “Mute” by voice, a | “Mute” | TBD |
| command key for muting the sound of a Player (separated by | | |
| Application ID) running on the source device is included in the | | |
| VCDC Input message. | | |
| Unmute-When a user delivers a command “Unmute” by voice, a | “Unmute” | TBD |
| command key for unmuting the sound of a Player (separated by | | |
| Application ID) running on the source device is included in the | | |
| VCDC Input message. | | |
| Original Size-When a user delivers a command “Original Size” by | “Original | TBD |
| voice, a command key for changing the size of the screen of a | Size” | |
| Player (separated by Application ID) running on the source device | | |
| into the “original size” is included in the VCDC Input message. | | |
| Full Screen-When a user delivers a command “Full Screen” by | “Full | TBD |
| voice, a command key for changing the size of the screen of a | Screen” | |
| Player (separated by Application ID) running on the source device | | |
| into the “full screen” is included in the VCDC Input message. | | |
| Internet-When a user delivers a command “Internet” by voice, a | “Internet” | TBD |
| command key for activating an Internet search application installed | | |
| in the source device is included in the VCDC Input message. | | |
| Target search word voice command - For example, when a user | “Target | TBD |
| instructs “LG Electronics” by voice command, a voice command | search | |
| “LG Electronics” is converted into ASCII and delivered to the | word voice | |
| source device. | command” | |
| Search-When a user delivers a command “Search” by voice, a | “Search” | TBD |
| command key for searching for items corresponding to the “target | | |
| search word voice command” instructed by a user through an | | |
| Internet search application installed in the source device is included | | |
| in the VCDC Input message. | | |

The voice commands exemplified in the present invention are merely a part of various embodiments, and voice commands for controlling various applications may be included in the VCDC input body or the VCDC input message proposed in the present invention and transmitted to the WFD source through the UIBC data.

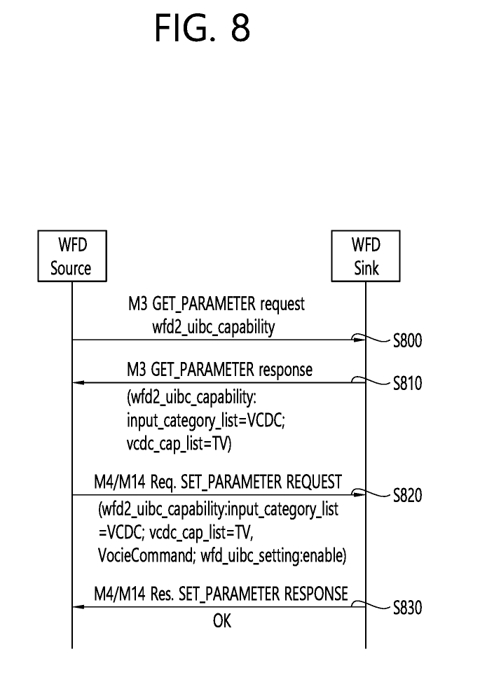

FIG. 8 is a flowchart illustrating a UIBC capability negotiation between a WFD source and a WFD sink according to an embodiment of the present invention.

Referring to FIG. 8, the WFD source may request a wfd2_uibc_capability parameter from the WFD sink through an RTSP M3 request message (operation S800).

The wfd2_uibc_capability parameter may include information about the Voice Command Device Category (VCDC) and voice command device type described above.

The WFD sink may send an RTSP M3 response message to the WFD source in response to the RTSP M3 request message (operation S810).

For example, the wfd2_uibc_capability parameter may include information about the input category (e.g., VCDC) and information about the VCDC capability (e.g., voice command device type (TV), supported voice command value information, etc.).

Through the above procedures, each of the WFD source and the WFD sink may mutually acquire information about the UIBC capability.

The WFD source may send an RTSP M4 request message to the WFD sink for UIBC capability negotiation (operation S820).

The RTSP M4 request message may also include a wfd2_uibc_capability parameter. Similarly, the wfd2_uibc_capability parameter may include information about the input category and information about the VCDC capability (e.g., information about voice command device type and supported voice command value, etc.).

The WFD sink may send an RTSP M4/M14 response message to the WFD source for UIBC capability negotiation (operation S830).

The RTSP M4/M14 response message may be sent for agreement on the values set by the RTSP M4 request message.

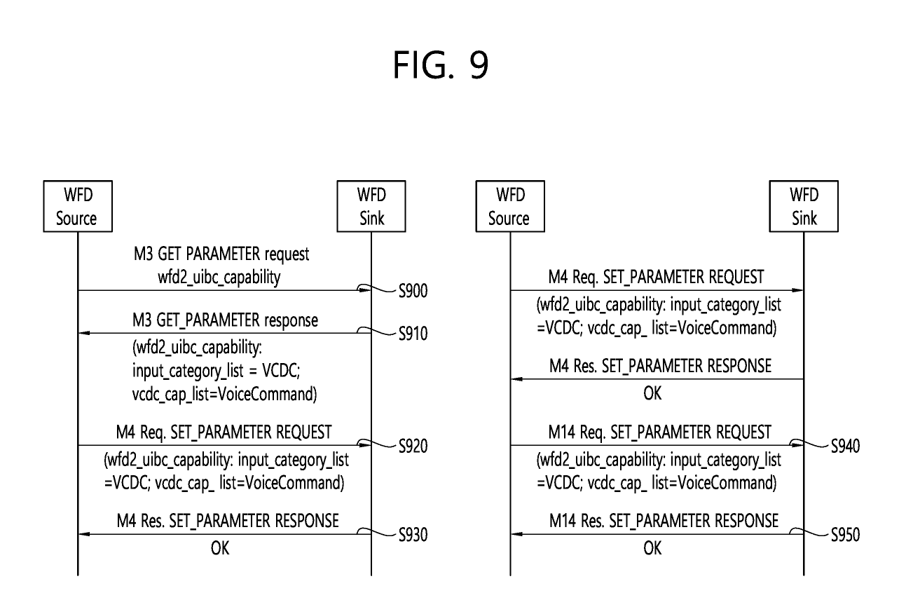

FIG. 9 is a flowchart illustrating a UIBC capability negotiation between a WFD source and a WFD sink according to an embodiment of the present invention.

Referring to FIG. 9, the WFD source may request a wfd2_uibc_capability parameter from the WFD sink through an RTSP M3 request message (operation S900).

The WFD sink may send an RTSP M3 response message to the WFD source in response to the RTSP M3 request message (operation S910).

The RTSP M3 response message may include a wfd2_uibc_capability parameter, and the wfd2_uibc_capability parameter may include information about the input category (e.g., VCDC) and information about the VCDC capability (e.g., voice command device type (TV) and supported voice command value information).

Through the above procedures, each of the WFD source and the WFD sink may mutually acquire information about the UIBC capability.

The WFD source may send an RTSP M4 request message to the WFD sink for UIBC capability negotiation (operation S920).

Also, the RTSP M4 request message may include a wfd2_uibc_capability parameter. Similarly, the wfd2_uibc_capability parameter may include information about the input category and information about the VCDC capability (e.g., voice command device type and supported voice command value).

The WFD sink may send an RTSP M4 response message to the WFD source for UIBC capability setup (operation S930).

That is, after the exchange of the RTSP M3 message, the capability negotiation for supporting a voice command may be performed through the UIBC in an RTSP initiation state through the RTSP M4 message.

The WFD source may send an RTSP M14 request message to the WFD sink for UIBC capability renegotiation (operation S940).

The WFD sink may perform UIBC capability renegotiation for voice command support with the WFD source through the M14 RTSP message in an RTSP playing state.

The RTSP M14 request message for the UIBC capability renegotiation may include a wfd2_uibc_capability parameter. Similarly, the wfd2_uibc_capability parameter may include information about the input category and information about the VCDC capability (e.g., voice command device type and supported voice command value).

The WFD source may send an RTSP M14 response message to the WFD sink for UIBC capability renegotiation (operation S950).

The RTSP M14 response message may be sent for agreement on the values reset by the RTSP M14 request message.

Table 8 below discloses a wfd2-uibc-capability parameter for supporting a voice command through the UIBC.

TABLE 8
wfd2-uibc-capability = “wfd2_uibc_capability:” SP (“none” / (input-category-val “;”
vcdc-cap-val “;” tcp-port)) CRLF; “none” if not supported
input-category-val = “input_category_list=” (“none” / input-category-list)
input-category-list = input-cat * (“,” SP input-category-list)
input-cat = “VCDC”
vcdc-cap-val = “vcdc_cap_list=” (“none” / vcdc-cap-list)
vcdc-cap-list = vcdc_cap *(“,” SP vcdc-cap-list)
vcdc-cap = “Play” / “Pause” / “Forward” / “Rewind” / “Previous” / “Next” / “Mute”
/ “UnMute” / “FullScreen” / “OriginalSize” / “ScreenRotation” / “none”
top-port = “port=” (“none” / IPPORT)

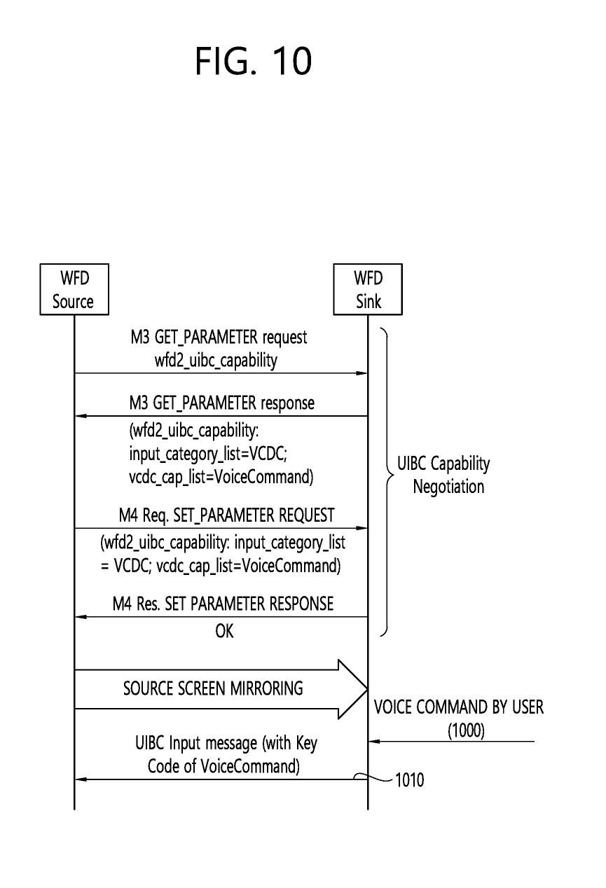

FIG. 10 is a flowchart illustrating a UIBC capability negotiation between a WFD source and a WFD sink according to an embodiment of the present invention.

Referring to FIG. 10, the UIBC capability negotiation procedure based on the RTSP M3 message/RTSP M4 message may be performed as shown in FIG. 9 described above.

Thereafter, the screen of the WFD source may be mirrored to a WFD sink.

Next, when a voice command is inputted to the WFD sink, the WFD sink may send a UIBC Input message to the WFD source. In this case, the UIBC input message may include a key code of a voice command (an operation code of a voice command) as shown in Table 7.

In an embodiment of the present invention, disclosed is a method in which the WFD sink controls the WFD source in such a manner that the WFD sink delivers a voice command of a user to the WFD source through the RTSP control message. When the UIBC capability negotiation procedure is performed to deliver a user voice command from the WFD sink to the WFD source through the RTSP control message, the wfd2-uibc-capability parameter may be transmitted through the RTSP M3 request/response message, the RTSP M4 request message, and the RTSP M14 request message. The wfd2-uibc-capability parameter may be defined as shown in Table 9 below.

TABLE 9
wfd2-uibc-capability = “wfd2_uibc_capability:” SP (“none” / (input-category-val “;” vcdc-
cap-val “;” tcp-port)) CRLF; “none” if not supported
input-category-val = “input_category_list=” (“none” / input-category-list)
input-category-list = input-cat * (“,” SP input-category-list)
input-cat = “VCDC”
vcdc-cap-val = “vcdc_cap_list=” (“none” / vcdc-cap-list)
vcdc-cap-list = vcdc_cap *(“,” SP vcdc-cap-list)
vcdc-cap = “Play” / “Pause” / “Forward” / “Rewind” / “Previous” / “Next” / “Mute” /
“UnMute” / “FullScreen” / “OriginalSize” / “ScreenRotation” / “none”
tcp-port = “port=” (“none” / IPPORT)

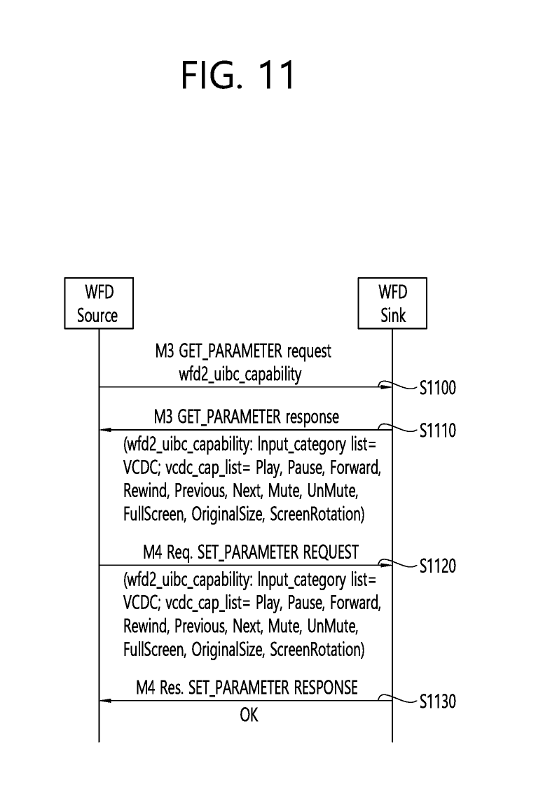

FIG. 11 is a flowchart illustrating a UIBC capability negotiation between a WFD source and a WFD sink according to an embodiment of the present invention.

Referring to FIG. 11, the WFD source may request a wfd2_uibc_capability parameter from the WFD sink through an RTSP M3 request message (operation S1100).

The WFD sink may send an RTSP M3 response message to the WFD source in response to the RTSP M3 request message (operation S1110).

The RTSP M3 response message may include a wfd2_uibc_capability parameter, and the wfd2_uibc_capability parameter may include information about the input category (e.g., VCDC) and information about the VCDC capability (e.g., supported voice command information). The supported voice command information may include play, pause, forward, rewind, previous, next, mute, unmute, full screen, original size, screen rotation, and the like.

Through the above procedures, each of the WFD source and the WFD sink may mutually acquire information about the UIBC capability.

The WFD source may send an RTSP M4 request message to the WFD sink for UIBC capability negotiation (operation S1120).

Also, the RTSP M4 request message may include a wfd2_uibc_capability parameter. Similarly, the wfd2_uibc_capability parameter may include information about the input category (e.g., VCDC) and information about the VCDC capability (e.g., information about supported voice command).

The WFD sink may send an RTSP M4 response message to the WFD source for UIBC capability setup (operation S1130).

That is, after the exchange of the RTSP M3 message, the capability negotiation for supporting a voice command may be performed through the UIBC in an RTSP initiation state through the RTSP M4 message.

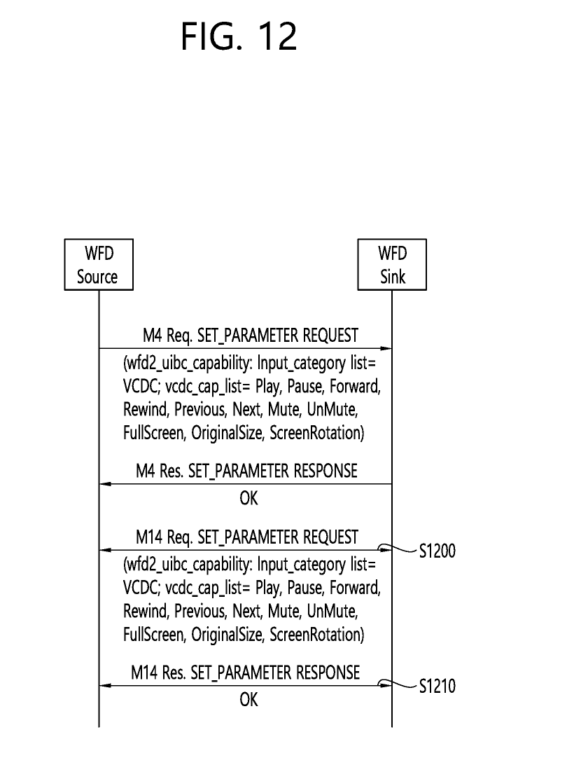

FIG. 12 is a flowchart illustrating a UIBC capability negotiation between a WFD source and a WFD sink according to an embodiment of the present invention.

Referring to FIG. 12, the WFD source may send an RTSP M14 request message to the WFD sink for UIBC capability renegotiation (or reset) (operation S1200).

The WFD source may perform UIBC capability renegotiation for voice command support with the WFD sink through the M14 RTSP control message in an RTSP playing state.

The WFD sink may send an RTSP M14 response message to the WFD source for UIBC capability renegotiation (operation S1210).

The RTSP M14 response message may be sent for agreement on the values set by the RTSP M14 request message.

On the other hand, referring to FIG. 12, the WFD sink may send an RTSP M14 request message for UIBC capability renegotiation (or reset) to the WFD source, and the WFD source may also send an RTSP M14 response message to the WFD sink for UIBC capability renegotiation.

Also, according to an embodiment of the present invention, a “wfd2-uibc-voice command (vc)-control” RTSP parameter for controlling an AV streaming screen of the WFD source through a user voice command may be defined. The wfd2-uibc-vc-control parameter is used for specific operations for supporting user voice commands through the UIBC. The portion expressed as “none” in the wfd2-uibc-voice command (vv)-control parameter may mean that the corresponding sub-parameter value is not supported.

TABLE 10
wfd2-uibc-vc-control = “wfd2_uibc_vc_control:” SP vc-control CRLF
vc-control = “Play” / “Pause” / “Forward” / “Rewind” / “Previous” / “Next” / “Mute” /
“UnMute” / “FullScreen” / “OriginalSize” / “ScreenRotation” / “none”

Table 11 below discloses the sub-parameters of the wfd2-uibc-voice command (vc)-control parameter included in M15 SET_PARAMETER.

TABLE 11

| | Key | |
|---|---|---|
| VoiceCommand | Code | Action |
| Play | TBD | Play-When a user delivers a command “Play” by voice, the |
| | | screen of a Player being mirrored from the source device to the |
| | | sink device is played. |
| Pause | TBD | Pause-When a user delivers a command “Pause” by voice, the |
| | | playback of a Player running in the source device is paused. |
| Forward | TBD | Forward-When a user delivers a command “Forward” by voice, |
| | | the playback screen of a Player running in the source device is |
| | | forwarded. |
| Rewind | TBD | Rewind - When a user delivers a command “Rewind” by voice, |
| | | the playback screen of a Player running in the source device is |
| | | rewinded. |
| Previous | TBD | Previous - When a user delivers a voice command “Previous” by |
| | | voice, a video to be played is changed to the previous video in |
| | | the playlist of a Player running in the source device. |
| Next | TBD | Next - When a user delivers a voice command “Next” by voice, |
| | | a video to be played is changed to the next video in the playlist |
| | | of a Player running in the source device. |
| Mute | TBD | Mute - When a user delivers a command “Mute” by voice, the |
| | | sound of a Player running in the source device is removed. |
| Unmute | TBD | Unmute - When a user delivers a command “Unmute” by voice, |
| | | the sound of a Player running in the source device is reactivated. |
| FullScreen | TBD | Full Screen - When a user delivers a command “Full Screen” by |
| | | voice, the screen being mirrored by a Player running in the |
| | | source device is changed into full screen size. |
| OriginalSize | TBD | When a user delivers a command “Originalsize” by voice, the |
| | | screen being mirrored by a Player running in the source device is |
| | | changed into original size. |
| ScreenRotation | TBD | Screen Rotation - Landscape - When a user delivers a command |
| | | “Screen Rotation” by voice, the playback screen of a Player |
| | | running in the source device is rotated. - For example, when the |
| | | current playback & mirroring screen is portrait type, the |
| | | playback screen is rotated into landscape type when a user |
| | | delivers a command “Screen Rotation” by voice. |

The voice commands exemplified in the present invention are merely a part of various embodiments, and voice commands for controlling various applications may be delivered to the WFD source through the RTSP control message proposed in the present invention.

In an embodiment of the present invention, the sub-parameters included in the proposed wfd2-uibc-voice command-control may be defined as bitmap formats. Table 12 shows the parameters included in the proposed wfd2-uibc-voice command-control and defined as bitmap formats.

TABLE 12

| Bit | |
|---|---|
| location | Name and Interpretation |
| B15:B11 | Reserved |
| B10 | 0b1: execution of “Play” 0b0: no execution of “Play” |
| B9 | 0b1: execution of “Pause” 0b0: no execution of “Pause” |
| B8 | 0b1: execution of “Forward” 0b0: no execution of “Forward” |
| B7 | 0b1: execution of “Rewind” 0b0: no execution of “Rewind” |
| B6 | 0b1: execution of “Previous” 0b0: no execution of “Previous” |
| B5 | 0b1: execution of “Next” 0b0: no execution of “Next” |
| B4 | 0b1: execution of “Mute” 0b0: no execution of “Mute” |
| B3 | 0b1: execution of “Unmute” 0b0: no execution of “Unmute” |
| B2 | 0b1: execution of “FullScreen” 0b0: no execution of |
| | “FullScreen” |
| B1 | 0b1: execution of “OriginalSize” 0b0: no execution of |
| | “OriginalSize” |
| B0 | 0b1: execution of “ScreenRocation” 0b0: no execution of |
| | “ScreenRotation” |

Referring to Table 12, sub-parameters may correspond to each bit included in the bitmap, and each bit of the bitmap may be set to 0 or 1 to deliver a specific voice command received from the WFD sink.

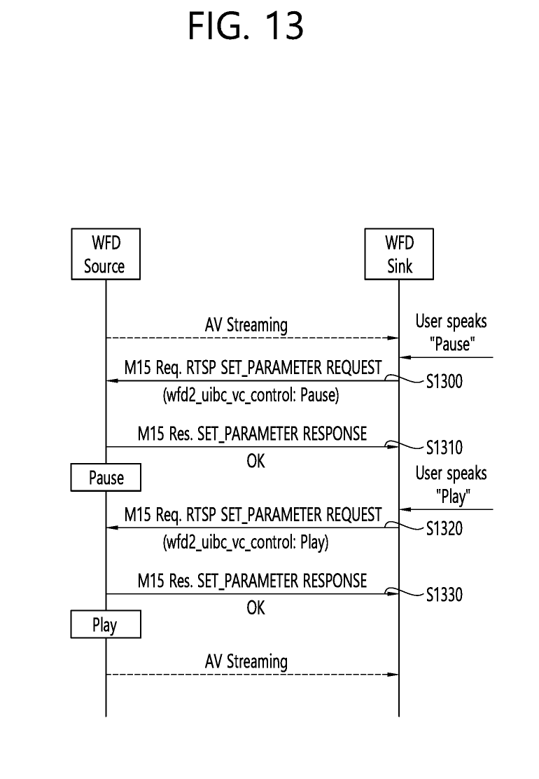

FIG. 13 is a conceptual view illustrating a method of transmitting an RTSP control message according to an embodiment of the present invention.

Referring to FIG. 13, the WFD source may perform AV streaming to the WFD sink.

A user may deliver a voice message “Pause” to the WFD sink.

The WFD sink may generate an RTSP M15 request message (M15 req. RTSP SET_PARAMETER REQUEST) based on the received voice message (“Pause”), and may transmit the RTSP M15 request message to the WFD source (operation S1300).

The RTSP M15 request message may include a wfd2-uibc-vc-control parameter, and the wfd2-uibc-vc-control parameter may include a key code or bitmap corresponding to the Pause.

The WFD source may send an RTSP M15 response message (M15 res. RTSP SET_PARAMETER RESPONSE) to the WFD sink (operation S1310).

The WFD source may pause the played video in accordance with an RTSP control message transmitted through the WFD sink.

A user may deliver a voice message “Play” to the WFD sink.

The WFD sink may generate an RTSP M15 request message (M15 req. RTSP SET_PARAMETER REQUEST) based on the received voice message (“Play”), and may transmit the RTSP M15 request message to the WFD source (operation S1320).

The RTSP M15 request message may include a wfd2-uibc-vc-control parameter, and the wfd2-uibc-vc-control parameter may include a key code or bitmap corresponding to the Play.

The WFD source may send an RTSP M15 response message (M15 res. RTSP SET_PARAMETER RESPONSE) to the WFD sink (operation S1330).

The WFD source may play back the paused video in accordance with an RTSP control message transmitted through the WFD sink.

Hereinafter, in an embodiment of the present invention, disclosed is a method in which the WFD sink includes a voice command of a user in audio low data and delivers the audio low data to the WFD source through a UIBC input message to control the WFD source.

In other words, the user's voice command is encoded into one of the following various formats of audio file formats in the WFD sink, and the encoded audio file may be included in the UIBC input message to be sent to the WFD source.

The audio file format may be 3gp, act, aiff, aac, amr, au, awb, dct, dss, dvf, mp3, m4a, ra, raw, wma, way, or the like. The WFD source may extract a user voice by decoding the audio file included in the UIBC input message. The extracted user voice may be re-interpreted as a key code value of the UIBC voice command defined in the present invention, and may be transmitted to an upper layer. Also, the streaming screen of the WFD source may be controlled according to the key code of the transmitted user voice command.

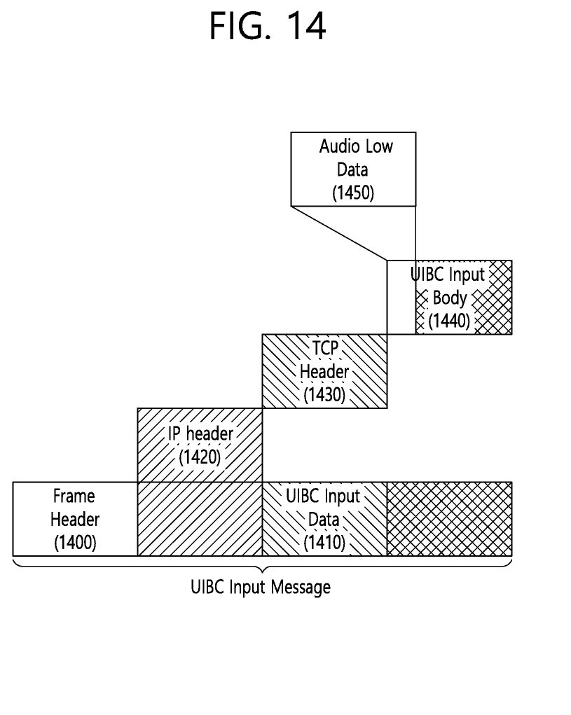

FIG. 14 is a conceptual view illustrating a UIBC input message format according to an embodiment of the present invention.

Referring to FIG. 14, a UIBC input message may include a frame header 1400 and UIBC input data 1410.

The UIBC input data 1410 may include an Internet Protocol (IP) header 1420, a TCP header 1430, and a UIBC input body 1440.

The UIBC input body 1440 may include audio low data 1450.

The IP header 1420/TCP header 1430 may include control information for transmission and interpretation of the UIBC input body 1440.

The UIBC input body 1440 may include an audio file format into which a user's voice is encoded.

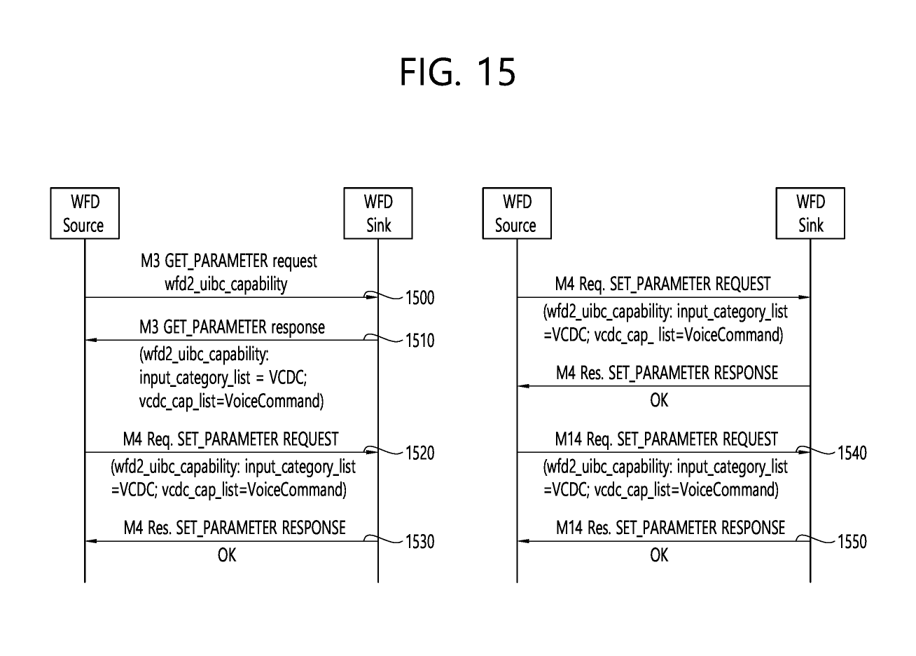

FIG. 15 is a flowchart illustrating a UIBC capability negotiation method according to an embodiment of the present invention.

Referring to FIG. 15, the WFD source may send an RTSP M3 request message 1500 to the WFD sink.

The RTSP M3 Request message 1500 may include a wfd2_uibc_capability parameter.

The wfd2_uibc_capability parameter may be used for UIBC capability negotiation to send and receive voice commands over a UIBC input message including an audio file between the WFD source and the WFD sink.

When the UIBC capability negotiation is performed, information indicating a voice command device category included in the wfd2_uibc_capability parameter and information (e.g., voice command information) about the capability of the voice command device category may be included.

After an exchange of the RTSP M3 request message 1500/RTSP M3 response message 1510, a capability negotiation procedure for voice command support using the UIBC in the RTSP initialization state through the RTSP M4 request message 1520/RTSP M4 response message 1530 may be performed.

Also, in the RTSP playing state, the WFD source or the WFD sink may re-perform the capability negotiation procedure for voice command support using the UIBC through the RTSP M14 request message 1540/RTSP M14 response message 1550.

An audio file including a voice command as shown in Table 7 described above is inputted from the WFD sink to the WFD source, and the screen being mirrored to the WFD sink by the WFD source may be controlled by the WFD sink. An audio file including a voice command is transmitted through the UIBC input message, and the audio file may be reinterpreted in the WFD source and accurately interpreted as a key code corresponding to the voice command.

In an embodiment of the present invention, a voice command device category is newly defined to support voice command processing through the UIBC, and a VCDC input type for a user input of the voice command device category may be defined as shown in Table 13 below.

TABLE 13

| VCDC Input Type ID | Notes |
|---|---|
| 0 | VoiceCommand |
| 1-255 | Reserved |

In an embodiment of the present invention, the voice command of a user inputted from the WFD sink may be included in the UIBC data to be transmitted to the WFD source. Accordingly, the screen being mirrored from the WFD source to the WFD sink may be controlled by the WFD sink. For this, a Voice Command (VC) value (or voice command key code) may be included in the VCDC input body.

TABLE 14

| | | |
|---|---|---|
| Field | Size | Notes |

| | |
|---|---|
| Voice Command Key code | see Table 7 |

The wfd2-uibc-capability parameter may be defined as below.

TABLE 15
wfd2-uibc-capability = “wfd2_uibc_capability:” SP (“none” / (input-category-val “;” vcdc-
cap-val “;” tcp-port)) CRLF; “none” if not supported
input-category-val = “input_category_list=” (“none” / input-category-list)
input-category-list = input-cat * (“,” SP input-category-list)
input-cat = “VCDC”
vcdc-cap-val = “vcdc_cap_list=” (“none” / vcdc-cap-list)
vcdc-cap-list = vcdc_cap *(“,” SP vcdc-cap-list)
vcdc-cap = “VoiceCommand
tcp-port = “port=” (“none” / IPPORT)

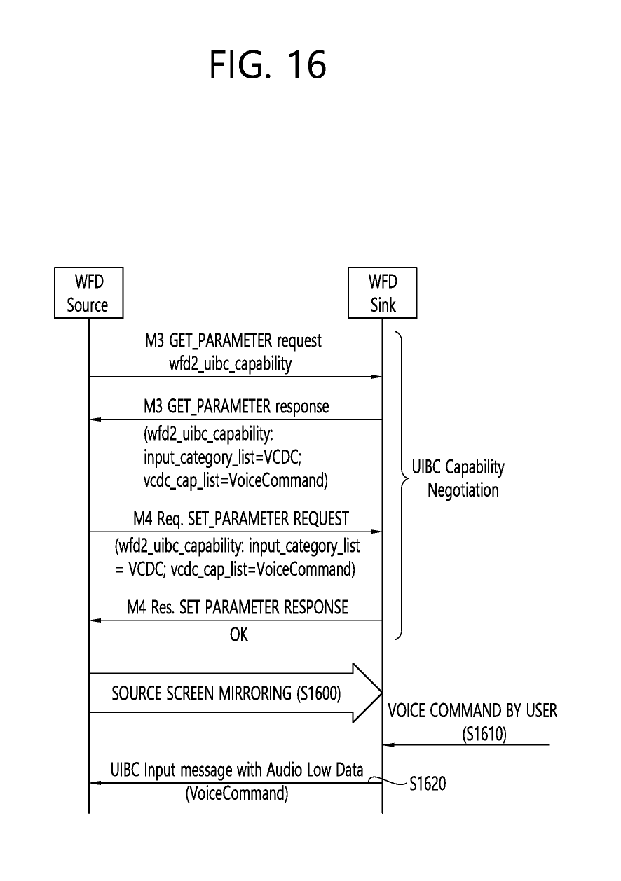

FIG. 16 is a flowchart illustrating a UIBC capability negotiation method according to an embodiment of the present invention.

Referring to FIG. 16, a UIBC capability negotiation procedure may be performed with the WFD source and the WFD sink based on RTSP M3 request/response messages and RTSP M4 request/response messages.

The screen of the WFD source may be mirrored to a WFD sink (operation S1600).

Thereafter, a voice command may be inputted through the WFD sink (operation S1610), and the WFD sink may transmit a UIBC input message including an audio low file format to the WFD source (operation S1620).

The WFD source may decode the audio low file to determine a key code corresponding to the voice command, and then may perform an operation corresponding to the key code.

According to an embodiment of the present invention, the WFD sink may control the WFD source by delivering a voice command of a user to the WFD source through a Reverse Audio Channel (RAC).

That is, user voice commands may be delivered to the WFD source in audio streaming through the RAC.

Table 16 below discloses bits indicating whether or not a Reverse Audio Channel (RAC) is supported.

TABLE 16

| | | |
|---|---|---|
| Bits | Name | Interpretation |

| | |
|---|---|
| Reverse Channel Audio | 0b0: Not supported |
| Support Bit | 0b1: Supported |

For example, bits indicating whether or not RAC is supported may be added to the extended capabilities bitmap to be used for negotiation between the WFD source and the WFD sink when performing capability negotiation.

The wfd2-rac-audio-formats parameters may be defined as shown in Table 17 below to indicate the support of the RAC.

TABLE 17
wfd2-rac-audio-formats = “wfd2_rac_audio_formats:” SP rac-audio-cap CRLF

| | |
|---|---|
| rac-audio-cap | = “none” / rac-audio-list; “none” if not supported at the WFD R2 Sink |

| | |
|---|---|
| rac-audio-list | = audio-format SP modes SP latency *(“,” SP rca-audio-list) |
| audio-format | = “LPCM” / “AAC” / “AC3” |

| | |
|---|---|
| modes | = 8*8HEXDIG; |
| latency | = 2*2HEXDIG; decoder latency in units of 5 msecs, |

According to an embodiment of the present invention, a “wfd2-rac-control” RTSP control parameter may be used when the voice command of a user is transmitted through the RAC.

The wfd2-rac-control parameters proposed in the present invention are as follows.

TABLE 18

| | |
|---|---|
| wfd2-rac-control | = “wfd2_rac_control:” SP rac-command SP rac_vc_control CRLF |

rac-command = (“disable”/ (“enable; audio_input =” audio_content_type))

| | |
|---|---|
| audio-content-type | = “CONV_VOICE” / “OTHER_VOICE”/ “ANY_AUDIO” |

Referring to Table 18, CONY_VOICE may indicate a conversational voice that requires real-time or latency critical handling.

OTHER_VOICE, which is an audio signal transmitted by a microphone input, may be a voice used for voice recognition. OTHER_VOICE may not be critical in latency compared to CON_VOICE.

ANY_AUDIO may be audio contents that do not critically require real-time or latency.

According to an embodiment of the present invention, a voice command of a user inputted from the WFD sink may be included in an audio stream through the RAC to be transmitted to the WFD source. Accordingly, the screen being mirrored from the WFD source to the WFD sink may be controlled by the WFD sink.

The voice commands as defined in Table 7 may be included in the audio stream to be delivered to the WFD source through the RAC, and the WFD source may determine key codes corresponding to the voice commands and reinterpret the key codes into voice commands.

The voice commands exemplified in FIG. 7 are merely a part of various embodiments, and voice commands for controlling various applications may be delivered to the WFD source through the audio stream via the RAC proposed in the present invention.

In an embodiment of the present invention, RAC RTSP parameters for voice command support may be defined as shown in Table 19 below.

TABLE 19

| Parameter | | | |
|---|---|---|---|
| name | Parameter description | Method | Usage |
| wfd2-rac- | Audio format(s) | GET | Optional in M3 request. |
| audio- | supported by the WFD | | Mandatory in RTSP M3 |
| formats | R2 Source or WFD R2 | | |
| | Sink for audio | | |
| | streaming in reverse | | |
| | audio channel. | | |
| wfd2-rac- | Enable or disable the | SET | Optional in RTSP M4/M17 |
| control | RAC | | request. |
| | | | Mandatory in RTSP M18 |
| | | | request. |

Referring to Table 19, the wfd2-rac-audio-formats parameter may include information about the audio formats supported by the WFD source or WFD sink for audio streaming in the RAC. The wfd2-rac-audio-formats parameter may be delivered through the RTSP M3 message.

The wfd2-rac-control parameter may be defined to enable/disable the RAC. The wfd2-rac-control parameter may be included in the RTSP M4/M17 request message and RTSP M18 request message to be transmitted.

The RTSP M17 message may be used to reset the RAC by the WFD R2 devices (WFD source/WFD sink) during the WFD session. The RTSP M18 message may be used to enable/disable the RAC at the WFD R2 devices (WFD source/WFD sink) during the WFD session.

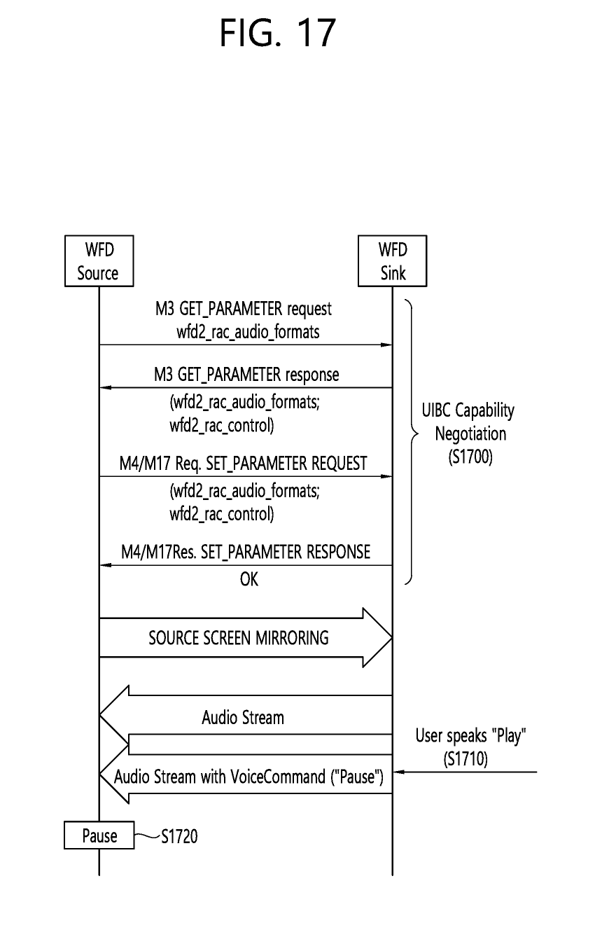

FIG. 17 is a flowchart illustrating a capability negotiation and capability negotiation procedure of a RAC for delivering voice commands according to an embodiment of the present invention.

In FIG. 17, the M3 request message/M3 response message and the M4 request message/M17 request message may be used for UIBC capability negotiation.

Referring to FIG. 17, the WFD source and the WFD sink may set a Reverse Audio Channel (RAC) through RTSP capability negotiation (operation S1700), and the audio stream may be delivered from the WFD sink to the WFD source according to the setting of the RAC.

If a user pronounces a “Pause” by a voice command (operation S1710), the voice command (“Pause”) may be transmitted to the WFD source through the RAC. The WFD source may determine a key code corresponding to the voice command defined in the present invention corresponding to the received voice, and perform an operation corresponding to the key code (operation S1720).

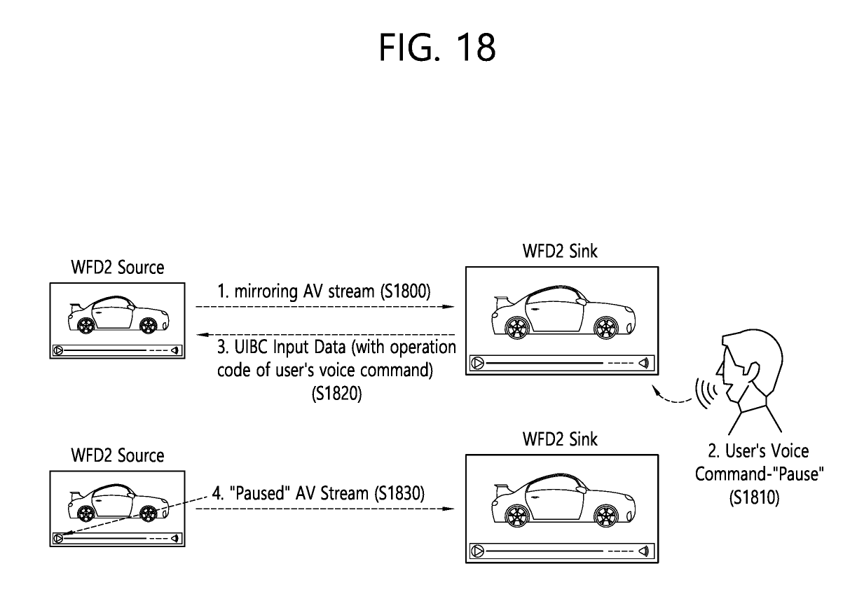

FIG. 18 is a conceptual view illustrating a method of transmitting a voice command of a user through a UIBC according to an embodiment of the present invention.

In FIG. 18, the WFD source may mirror an AV stream to the WFD sink (operation S1800).

A user may input a command “Pause” into the WFD sink (operation S1810), and the command inputted through the WFD sink may be transmitted to the WFD source as UIBC input data including the operation code (or key code) corresponding to the voice command of a user (operation S1820).

The WFD source may pause the AV stream (operation S1830).

Table 20 below defines voice commands as new input categories.

TABLE 20

| Input Category | Category | Notes |
|---|---|---|
| 0 | Generic | User input data is (are) formatted |
| | | using the Generic Input Body. |
| 1 | HIDC | User input data is (are) formatted |
| | | using the HIDC Input Body. |
| 2 | VC | User input data is (are) formatted |
| | | using VC Input Body. |
| 23-15 | Reserved | |

That is, a voice command may be defined as a separate input category, and may be defined and transmitted as a separate input body.

Table 21 below shows a syntax of the wfd2-uibc capability parameter.

TABLE 21

| | |
|---|---|
| wfd2-uibc-capability | = “wfd2_uibc_capability:” SP (“none” / (input-category-val “;” |

generic-cap-val “;”hidc-cap-val “;” vc-cap-val “;” tcp-port)) CRLF; “none” if not supported

| | |
|---|---|
| input-category-val | = “input_category_list=” (“none” / input-category-list) |
| input-category-list | = input-cat * (“,” SP input-category-list) |

| | |
|---|---|
| input-cat | = “GENERIC” / “HIDC” / “VC” |
| generic-cap-val | = “generic_cap_list=” (“none” / generic-cap-list) |
| generic-cap-list | = inp-type *(“,” SP generic-cap-list) |

inp-type= “Keyboard” / “Mouse” / “SingleTouch” / “MultiTouch” / “Joystick” / “Camera” /
“Gesture” / “RemoteControl”

| | |
|---|---|
| hidc-cap-val | = “hidc_cap_list=” (“none” / hidc-cap-list) |
| hidc-cap-list | = detailed-cap *(“,” SP hidc-cap-list) |
| detailed-cap | = inp-type “/” inp-path |

inp-path= “Infrared” / “USB” / “BT” / “Zigbee” / “Wi-Fi” / “No-SP”; “No-SP” means vendor
specific
tcp-port = “port=” (“none” / IPPORT)

Referring to Table 21, it can be seen that “VC” is defined as a separate input category in the syntax of the wfd2-uibc capability parameter.

According to an embodiment of the present invention, a new RTSP parameter may be defined that indicates which device has the ability to interpret the voice command of a user.

For example, a wfd2-vc-translation parameter may be defined, and the wfd2-vc-translation parameter may indicate whether or not the ability to interpret voice commands exists.

Table 22 below shows the wfd2-vc-translation parameter.

TABLE 22
wfd2-vc-translation = “wfd2_vc_translation:” SP translation-capability
CRLF

| | |
|---|---|
| translation-capability | = source “/” sink “/” none |

Referring to Table 22, the wfd2-vc-translation parameter may indicate which one of the WFD source and the WFD sink performs an interpretation of the voice command to determine a key code corresponding to the voice command.

When the WFD source supports voice commands through the UIBC, the WFD source transmits the wfd2-vc-translation parameter through the RTSP M4 Request message to indicate which one of the WFD source and WFD sink interprets the voice command and determines the key code corresponding to the voice command.

The WFD sink may receive the RTSP M4 request message from the WFD source, and may transmit an RTSP M4 response message in response to the RTSP M4 request message.

Specifically, when the WFD sink has the capability (translation-capability) to determine the key code corresponding to the voice command by performing interpretation of the voice command, the WFD sink may interpret an audio input in which the voice command is included, and then may determine a key code (or translated value) corresponding to the voice command. The WFD sink may send user input data including the corresponding key code (or translated value) to the WFD source. The WFD source may receive the user input data that includes the key code (or interpreted value), and may process the user voice command based on the key code (or interpreted value).

On the contrary, when the WFD source has the capability (translation-capability) to determine the key code corresponding to the voice command by performing interpretation of the voice command, the WFD sink may transmit user input data (VCDC input body/VCDC input message) including the audio data including the voice command to the WFD source. That is, the WFD sink may send user input data including audio low data corresponding to the voice command of a user to the WFD source. The WFD source may receive the user input data including the audio low data, may interpret the audio low data, and then may determine a key code corresponding to the audio low data to process the voice command of a user.

Table 23 below shows a VC input body format for supporting a UIBC voice command.

TABLE 23

| | Size | |
|---|---|---|
| Field | (Octet) | Notes |
| Length | 2 | Length of the following fields in octets |
| Describe | Variable | The details of the user inputs (i.e., operation |
| | | code of User's Voice Command) or Audio Low |
| | | Data of User's Voice Command. |
| | | If the wfd2-voicecommand-translation is set to |
| | | “Sink”, the Operation Code(or key code) of |
| | | User's Voice Command is included in VC Input |
| | | Body. If the wfd2-voicecommand-translation is |
| | | set to “Source”, the Audio Low Data of User's |
| | | Voice Command is included in VC Input Body. |

Table 24 below discloses the operation codes according to the voice commands.

TABLE 24

| Input | Action | Operation Code |
|---|---|---|
| “Play” | Start AV streaming of the player | 1 |
| “Pause” | Temporary suspension of the | 2 |
| | player | |
| “Forward” | Forward to advance the screen as | 3 |
| | it play | |
| “Rewind” | Put a screen recording back to | 4 |
| | the beginning | |
| “Mute” | Remove sound | 5 |
| “Unmute” | Activate sound | 6 |
| Vendor specific | Vendor specific usage | Vendor specific |
| input | | value |

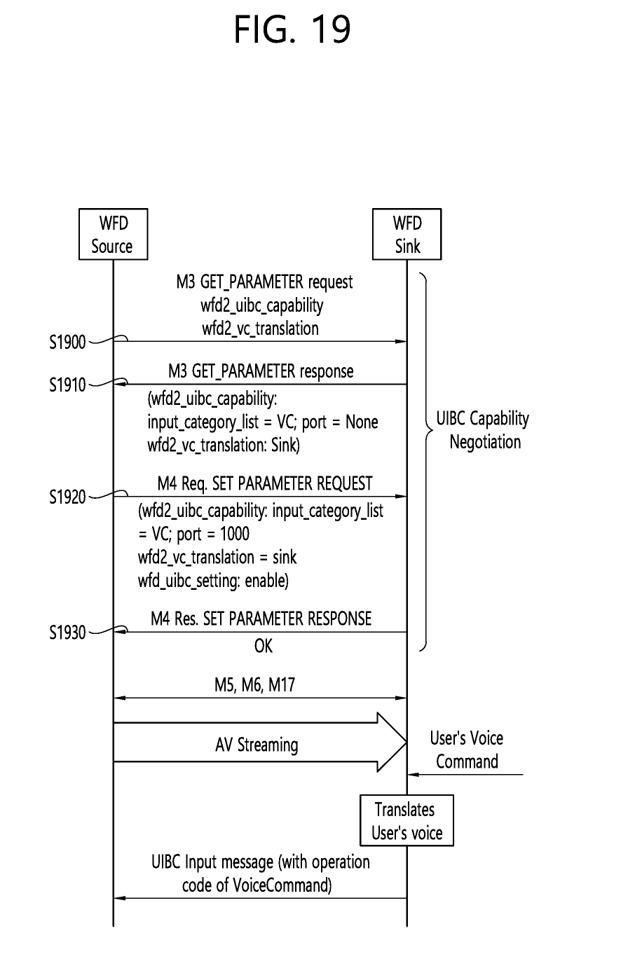

FIG. 19 is a conceptual view illustrating a method of transmitting a voice command of a user through a UIBC according to an embodiment of the present invention.

Referring to FIG. 19, the WFD source may send an RTSP M3 request message to the WFD sink (operation S1900).

The RTSP M3 request message may include a wfd2_uibc_capability parameter and a wfd2_vc_translation parameter.

The WFD sink may send an RTSP M3 response message to the WFD source (operation S1910).

The RTSP M3 response message may include the wfd2_uibc_capability parameter and the wfd2_vc_translation parameter.

The wfd2_uibc_capability parameter may include information about input categories (e.g., VCDC) and information about a port. The wfd2_vc_translation parameter may include information about the voice command interpretation capability of the WFD source/WFD sink.

The WFD source may send an RTSP M4 Request message to the WFD sink (operation S1920).

The RTSP M4 request message may be used to set the UIBC parameter for voice commands. The RTSP M4 request message may include a wfd2_uibc_capability parameter, a wfd2_vc_translation parameter, and a wfd_uibc_setting parameter.

As described above, according to the wfd2_vc_interpretation parameter, it may be determined whether the WFD sink interprets the voice command or whether the WFD source interprets the voice command.

The WFD sink may send an RTSP M4 response message to the WFD source (operation S1930).

Thereafter, the transmission/reception of the RTSP M5/M6/M7 request/response messages may be performed, and the WFD source may transmit data to the WFD sink through AV streaming.

Next, when a voice command of a user is inputted, the WFD sink may interpret the voice command of a user, and may determine an operation code (key code) corresponding to the voice command of a user.

The WFD sink may include the operation code corresponding to the voice command of a user in a UIBC input message (or UIBC data), and may transmit the UIBC input message to the WFD source.

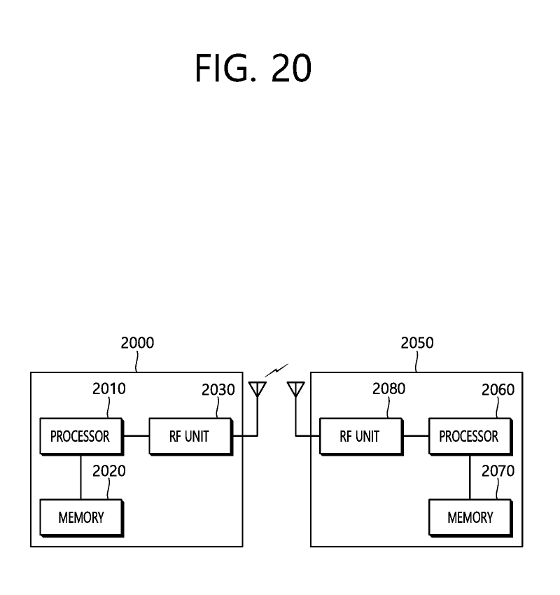

FIG. 20 is a view illustrating a wireless device to which an embodiment of the present invention can be applied.

Referring to FIG. 20, the wireless device may be a WFD source 2000 (or a first WFD device) and a WFD sink 2050 (or a second WFD device) which can implement the embodiments described above.

The WFD source 2000 includes a processor 2010, a memory 2020, and a communication unit 2030.

The RF unit 930 may be connected to the processor 910 to transmit/receive radio signals.

The processor 2010 may implement the functions, processes, and/or methods proposed in the present invention. For example, the processor 2010 may be implemented to perform operations of the WFD source 2000 according to the above-described embodiments of the present invention. The processor 2010 may perform the operations of the WFD source 2000 disclosed in the embodiments of FIGS. 1 to 19.

For example, the processor 2010 may send, to the second WFD device, an RTSP M3 request message for requesting information about the VCDC capability of the second WFD device, and may receive an RTSP M3 response message from the second WFD device in response to the RTSP M3 request message. The RTSP M3 response message may include input category information and VCDC capability information set to VCDC of the second WFD device.

Also, the processor 2010 may be implemented to transmit, to a second WFD device, an RTSP M4 request message including input category information and initial setting VCDC capability information set to VCDC in a Real-Time Streaming Protocol (RTSP) initiation state, and to receive an RTSP M4 response message from the second WFD device in response to the RTSP M4 request message.

The first WFD device may be a device that supports the streaming of multimedia contents, and the second WFD device may be a device that receives and renders multimedia contents from the first WFD device through a Peer-To-Peer (P2P) link with the first WFD device.

The VCDC capability information may include information about a plurality of voice-based operation control commands for control of multimedia contents played in the first WFD device by the second WFD device and played in the second WFD device, respectively.

Also, the processor 2010 may send an RTSP M14 request message for resetting of the initial setting VCDC capability information in an RTSP playing state to the second WFD device, where the RTSP M14 request message includes resetting VCDC capability information for resetting of the input category information and initial setting VCDC capability information set to the VCDC, and an RTSP M14 response message is received from the second WFD device in response to the RTSP M14 request message.

In addition, the processor 2010 may receive UIBC data for voice commands from the second WFD device, where the UIBC data include a VCDC input body, the VCDC input body includes a VCDC command device type identifier field, an application identifier field, and a voice command value field, the VCDC command device type identifier field includes information about a device type of the second WFD device, the application identifier field includes identifier information of an application driven for play of multimedia contents in the first WFD device controlled based on the UIBC data, and the voice command value field includes at least one key code corresponding to at least one operation control command among a plurality of key codes corresponding to a plurality of operation control commands.

As described above, the RTSP M3 response message may further include information on whether or not the Reverse Audio Channel (RAC) is supported. The UIBC data may be transmitted through the RAC set between the first WFD device and the second WFD device, and may be classified according to whether or not real-time processing is necessary.

Also, the RTSP M4 request message may further include a translation capability parameter, and the translation capability parameter may indicate which one of the first WFD device and the second WFD device determines at least one key code corresponding to at least one operation control command.

The WFD sink 2050 includes a processor 2060, a memory 2070, and a communication unit 2080.

The RF unit 2080 may be connected to the processor 2060 to transmit/receive radio signals.

The processor 2060 may implement the functions, processes, and/or methods proposed in the present invention. For example, the processor 2060 may be implemented to perform operations of the WFD sink 2050 according to the above-described embodiments of the present invention. The processor 2060 may perform the operations of the WFD sink (or the second WFD device) 2050 in the embodiments of FIGS. 1 to 19.

For example, the processor 2060 may be implemented to send an RTSP M3 response message to the first WFD device in response to the RTSP M3 request message, and send an RTSP M4 response message to the first WFD device in response to the RTSP M4 request message.

Also, the processor 2060 may be implanted to receive an RTSP M14 request message for resetting the initial setting VCDC capability information in an RTSP playing state, and transmit an RTSP M14 response message from the second WFD device in response to the RTSP M14 request message.

The processors 2010 and 2060 may include Application-Specific Integrated Circuits (ASICs), other chipsets, logic circuits, data processing devices, and/or converters for mutually converting baseband signals and radio signals. The memories 2020 and 2070 may include Read-Only Memory (ROM), Random Access Memory (RAM), flash memory, memory card, storage media, and/or other storage devices. The RF units 2030 and 2080 may include one or more antennas for transmitting and/or receiving radio signals.

When the embodiments are implemented in software, the above-described techniques may be implemented as a module (process, function, etc.) that performs the above-described functions. The module may be stored in the memories 2020 and 2070, and may be executed by the processors 2010 and 2060. The memories 2020 and 2070 may be internal or external to the processors 2010 and 2060, and may be connected to the processors 2010 and 2060 in various well-known ways.

What is claimed is:

1. A method for processing a voice command through a User Input Back Channel (UIBC), the method comprising:
sending, a first WiFi Display (WFD) device, a Real-Time Streaming Protocol (RTSP) Message (M) 3 request message to a second WFD device to request information about a Voice Command Device Category (VCDC) capability of the second WFD device;
receiving, by the first WFD device, an RTSP M3 response message in response to the RTSP M3 request message from the second WFD device, the RTSP M3 response message comprising input category information and VCDC capability information set to the VCDC of the second WFD device;
sending, by the first WFD device, an RTSP M4 request message in an RTSP initiation state to the second WFD device, the RTSP M4 request message comprising input category information and initial setting VCDC capability information set to the VCDC; and
receiving, by the first WFD device, an RTSP M4 response message from the second WFD device in response to the RTSP M4 request message,
wherein:
the first WFD device is a device supporting streaming of multimedia contents,
the second WFD device is a device receiving and rendering the multimedia contents from the first WFD device through a Peer-to-Peer (P2P) link with the first WFD device, and
the VCDC capability information comprises information about a plurality of voice-based operation control commands for control of the multimedia contents played in the first WFD device and the second WFD device by the second WFD device, respectively.

2. The method of claim 1, further comprising:
sending, by the first WFD device, an RTSP M14 request message for resetting of the initial setting VCDC capability information in an RTSP playing state to the second WFD device, the RTSP M14 request message comprising resetting VCDC capability information for resetting of the input category information and initial setting VCDC capability information set to the VCDC; and
receiving, by the first WFD device, an RTSP M14 response message from the second WFD device in response to the RTSP M14 request message.

3. The method of claim 1, further comprising receiving, by the first WFD device, UIBC data for the voice command from the second WFD device,
wherein:
the UIBC data comprise a VCDC input body;
the VCDC input body comprises a VCDC command device type identifier field, an application identifier field, and a voice command value field,
the VCDC command device type identifier field comprises information about a device type of the second WFD device,
the application identifier field comprises identifier information of an application driven for play of the multimedia contents in the first WFD device controlled based on the UIBC data, and
the voice command value field comprises at least one key code corresponding to at least one operation control command among a plurality of key codes corresponding to the plurality of operation control commands.

4. The method of claim 3, wherein:
the RTSP M3 response message further comprises information about whether a Reverse Audio Channel (RAC) is supported,
the UIBC data are delivered through the RAC set between the first WFD device and the second WFD device, and
the UIBC data are classified according to whether or not real-time processing is required.

5. The method of claim 4, wherein the RTSP M4 request message further comprises a translation capability parameter, and
the translation capability parameter indicates which one of the first WFD device and the second WFD device determines the at least one key code corresponding to the at least one operation control command.

6. A first WiFi Display (WFD) device for performing voice command processing through a User Input Back Channel (UIBC), the device comprises:
a communication unit for communicating with a second WFD device; and
a processor operably connected to the communication unit,
wherein:
the processor sends a Real-Time Streaming Protocol (RTSP) M3 request message to
the second WFD device to request information about a Voice Command Device Category (VCDC) capability of the second WFD device,
receives an RTSP M3 response message in response to the RTSP M3 request message from the second WFD device, the RTSP M3 response message comprising input category information and VCDC capability information set to the VCDC of the second WFD device,
sends a RTSP M4 request message in an RTSP initiation state to the second WFD device, the RTSP M4 request message comprising input category information and initial setting VCDC capability information set to the VCDC, and
receives an RTSP M4 response message from the second WFD device in response to the RTSP M4 request message;
the first WFD device is a device supporting streaming of multimedia contents;
the second WFD device is a device receiving and rendering the multimedia contents from the first WFD device through a Peer-to-Peer (P2P) link with the first WFD device; and
the VCDC capability information comprises information about a plurality of voice-based operation control commands for control of the multimedia contents played in the first WFD device and the second WFD device by the second WFD device, respectively.

7. The device of claim 6, wherein the processor sends an RTSP M14 request message for resetting of the initial setting VCDC capability information in an RTSP playing state to the second WFD device, the RTSP M14 request message comprising resetting VCDC capability information for resetting of the input category information and initial setting VCDC capability information set to the VCDC, and
receives an RTSP M14 response message from the second WFD device in response to the RTSP M14 request message.

8. The device of claim 6, wherein:
the processor receives UIBC data for the voice command from the second WFD device:
the UIBC data comprise a VCDC input body;
the VCDC input body comprises a VCDC command device type identifier field, an application identifier field, and a voice command value field;
the VCDC command device type identifier field comprises information about a device type of the second WFD device;
the application identifier field comprises identifier information of an application driven for play of the multimedia contents in the first WFD device controlled based on the UIBC data; and
the voice command value field comprises at least one key code corresponding to at least one operation control command among a plurality of key codes corresponding to the plurality of operation control commands.

9. The device of claim 8, wherein:
the RTSP M3 response message further comprises information about whether a Reverse Audio Channel (RAC) is supported;
the UIBC data are delivered through the RAC set between the first WFD device and the second WFD device; and
the UIBC data are classified according to whether or not real-time processing is required.

10. The device of claim 9, wherein the RTSP M4 request message further comprises a translation capability parameter, and
the translation capability parameter indicates which one of the first WFD device and the second WFD device determines the at least one key code corresponding to the at least one operation control command.
